(19) United States
(12) Patent Application Publication
(10) Pub. No.: US 2005/0114020 A1
(43) Pub. Date: May 26, 2005

(54) Navigation device, car navigation program, display device, and display control program for presenting information on branch destination

(75) Inventors: Fumio Seto, Yokosuka-shi (JP); Masaki Watanabe, Yokohama-shi (JP); Okihiko Nakayama, Yokohama-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 10/992,781

(22) Filed: Nov. 22, 2004

(30) Foreign Application Priority Data
Nov. 25, 2003 (JP) P2003-393510
Dec. 2, 2003 (JP) P2003-402888

(51) Int. Cl. G01C 21/34

(52) U.S. Cl. 701/211; 340/995.1

(57) ABSTRACT

A navigation device includes a guide point selecting section selecting a guide point related to direction guide information among branch points on a travel path where a vehicle travels; a direction guide information generating section generating the direction guide information of the selected guide point; an output controlling section controlling output of the generated direction guide information; and an output section presenting the direction guide information. The direction guide information generating section generates the direction guide information in which the guide point is associated with display of the place name of the branch destination at the guide point.

### BACKGROUND OF THE INVENTION

The present invention relates to a navigation device, a car navigation program, a display device, and a display control program for presenting information on branch destination.

There has hitherto been known a navigation device which is mounted on a vehicle and displays a direction guide indication corresponding to a direction guide sign on a screen when the vehicle approaches a branch point such as an intersection, as disclosed in the Japanese Patent Laid-Open publication No. 2001-311625.

With such a navigation device, a direction guide in which an arrow indicating a branch direction of a road is associated with a letter string indicating a place name, and a driver can check again the place name of the branch destination on the screen of the navigation device even if missing the direction guide sign on the road.

### SUMMARY OF THE INVENTION

However, in the conventional navigation device, the direction guide is displayed separately from map information, and the driver cannot determine which branch point or which branch road is related to the direction guide. In this case, to check the place name of a branch destination and the like, the driver needs to perform an operation of scrolling displayed map information to follow the travel path and check the branch destination or an operation of changing the scale of the map information such that the branch destination is displayed. Such operations are very complicated for the driver. When there are a plurality of branch destinations, the driver is required to perform scrolling or scale change for each branch destination. Furthermore, when the driver is familiar with the geometry around the place where he/she is driving or when the vehicle is traveling to a facility located in the displayed map information or the like, scrolling and scale change of the map information are not preferable.

The present invention was made for solving the aforementioned problem, and an object thereof is to provide a navigation device, a car navigation program, a display device, and a display control program, which presents guide information including branch points or roads associated with direction guides.

In order to solve the aforementioned problem, a navigation device according to the present invention is a navigation device presenting direction guide information at a branch point of a travel path where a vehicle with the navigation device mounted thereon travels, the direction guide information including a place name of a branch destination of the travel path. The navigation device includes: a guide point selecting section selecting a guide point related to the direction guide information among branch points on the travel path; a direction guide information generating section generating the direction guide information of the guide point selected by the guide point selecting section; a display controlling section controlling outputting the direction guide information generated by the guide information generating section; and an output section presenting the direction guide information according to the control by the display controlling section. The direction guide information generating section generates the direction guide information in which the guide point is associated with display of the place name of the branch destination at the guide point.

A car navigation program according to the present invention is a program for car navigation causing a navigation computer mounted on a vehicle to execute a process. The navigation computer includes a function to present direction guide information including a place name of a branch destination of a travel path, where the vehicle travels, at a branch point of the travel path. The process includes: a step of selecting a guide point related to the direction guide information among branch points on the travel path; a step of generating the direction guide information of the selected guide point; a step of controlling outputting the generated direction guide information; and a step of presenting the direction guide information according to the control. The step of generating the direction guide information generates the direction guide information in which the guide point is associated with display of the place name of the branch destination at the guide point.

A display device according to the present invention is a display device mounted on a vehicle and includes: a screen including a map display area and a direction guide area; and a display controlling section controlling display on the screen. The display controlling section displays map information around the vehicle in the map display area of the screen and displays direction guide information including information of a branch destination related to a selected predetermined guide point in the direction guide display area.

A display control program according to the present invention causes a computer for controlling display of a display device mounted on a vehicle to execute the following steps: a step of selecting a guide point outside of map information which can be displayed in the screen among branch points on a travel path where the vehicle travels; a step of generating direction guide information including information of a branch destination related to the selected guide point; and a step of setting a direction guide area, in which the generated direction guide information is displayed, in the screen of the display device and displaying the direction guide information in the set direction guide area.

### BRIEF DESCRIPTION OF THE DRAWINGS

FIG. 1 is a block diagram of a navigation device according to a first embodiment of the present invention.

FIGS. 2A and 2B are views for explaining a process to select a guide point.

FIG. 3 is a flow chart showing a process procedure of the navigation device according to the first embodiment of the present invention.

FIG. 4 is a view for explaining the process procedure of the navigation device shown in FIG. 3.

FIG. 5 is a view for explaining the process procedure of the navigation device shown in FIG. 3.

FIG. 6 is a view for explaining the process procedure of the navigation device shown in FIG. 3.

FIG. 7 is a block diagram of a navigation device according to a second embodiment of the present invention.

FIG. 8 is a view for explaining a process to select a guide point.

FIG. 9 is a view for explaining the process to select a guide point.

FIGS. 10A and 10B are views for explaining a process to set a direction guide area.

FIG. 11 is a view for explaining a process to control display of the direction guide information.

FIG. 12 is a view for explaining the process to control display of the direction guide area.

FIG. 13 is a first flowchart showing a process procedure of the navigation device according to the second embodiment of the present invention.

FIGS. 14A and 14B are a second flowchart showing a process procedure of the navigation device according to the second embodiment of the present invention.

FIG. 15 is a view for explaining direction guide information.

FIGS. 16A and 16B are views for explaining the direction guide information.

FIGS. 17A and 17B are views for explaining the direction guide information.

FIG. 18 is a view for explaining the direction guide information.

FIG. 19 is a view for explaining the direction guide information.

FIG. 20 is a view showing an example of a display mode of the navigation device according to the second embodiment of the present invention.

### DETAILED DESCRIPTION OF THE PREFERRED EMBODIMENTS

Next, a description is given of navigation devices as embodiments of the present invention with reference to the drawings.

### First Embodiment

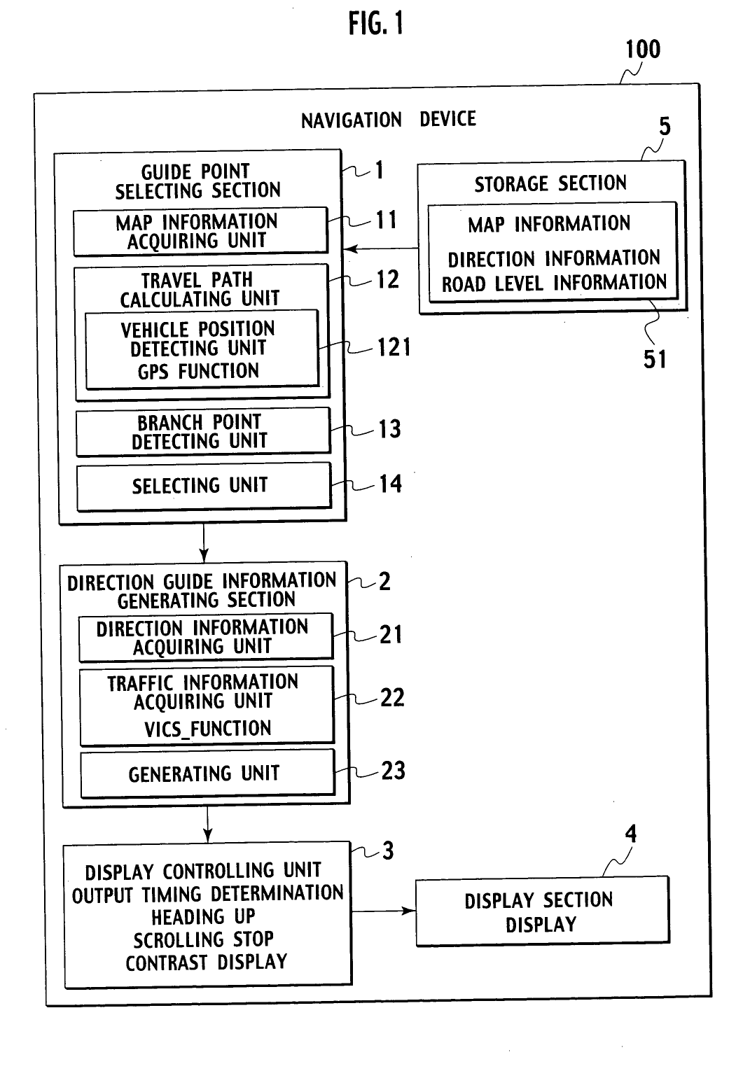

A navigation device 100 as a first embodiment of the present invention is, as shown in FIG. 1, includes a guide point selecting section 1, a direction guide information generating section 2, a display controlling section 3, a display section 4, and a storage section 5. More specifically, the navigation device 100 as the first embodiment of the present invention includes at least a ROM storing a program to select a guide point, a program to generate direction guide information related to the selected guide point, and a program to control displaying the direction guide information, a CPU executing the programs stored in this ROM and functioning as the guide point selecting section 1, the direction guide information generating section 2, and the display control section 3, and a RAM functioning as the accessible storage section 5.

The guide point selecting section 1 includes a map information acquiring unit 11, a travel path calculating unit 12, a branch point detecting unit 13, and a selecting unit 14. The guide point selecting section 1 selects a predetermined guide point among branch points on the travel path where a vehicle travels. Hereinafter, the vehicle means a vehicle on which the navigation device 100 according to the present invention is mounted. The selected guide point is a point related to direction guide information to be offered to a user. In other words, the navigation device 100 offers the user the direction guide information related to the selected guide point. The direction guide information includes branch destination information of the guide point. The branch destination information includes at least a name of the branch point, a destination of a road branching from the branch point, and a name of the road branching from the branch point.

The map information acquiring unit 11 accesses map information 51 of the storage section 5 and acquires the map information necessary for route guiding, map display, and direction guide information display. The map information 51 of this embodiment includes at least information necessary for offering of the map information and route guiding as performed by a general navigation device and necessary for displaying the direction guide information of the embodiment. The map information 51 includes at least road links indicating connecting states of nodes, locations of branch points (road nodes), names of roads branching from the branch points, and place names of the branch destinations, and has such a data structure that, by specifying a location of interest, information on the corresponding road and place name can be read. The map information 51 stores road information for each road link or node. The road information includes identification information of a road such as a road name, attribute information such as a road type, a road width, and a road administrator, a connection angle of a road at a branch point, and road level information concerning a road scale.

The travel path calculating unit 12 includes a vehicle location detecting function 121, and calculates a road where the vehicle is traveling and a road where the vehicle is going to travel based on the current position of the vehicle and the map information. Herein, a travel path where the vehicle travels includes the load where the vehicle is traveling and the road where the vehicle is predicted to travel. The method of calculating the travel path is not particularly limited, and the following method is used in this embodiment. Specifically, when adjacent two links have same identification information, the travel path calculating section 12 determines that the two adjacent links constitute a continuous road and predicting the road to be the travel path. When adjacent two links have same attribute information, the travel path calculating section 12 determines that the two adjacent links constitute a continuous road and predicts the road to be the travel path.

In addition, when a connection angle of two adjacent links is not less than a predetermined value, the travel path estimating unit 12 determines that, the two links constitute a continuous road and predicts the road to be the travel path. The travel path calculating unit 12 predicts at least a travel path by any one of or a combination of two or more of these three techniques. The prediction of the travel path by the travel path calculating unit 12 allows the later-described selecting section 14 to select branch points on a path where the vehicle is highly likely to travel.

The branch point detecting unit 13 detects the branch points on the calculated travel path. The branch point detecting unit 13 refers to location information of road intersections included in the road information of the map information 51 and detects the branch points on the calculated travel path.

The selecting unit 14 selects a guide point related to the direction guide information among the branch points detected by the branch point detecting unit 13. The selecting section 14 of this embodiment acquires a road level concerning the road scale which is previously associated with each link included in the map information 51. The road level is an indicator concerning the road scale determined based on factors of the road type (an expressway, a toll road, a national road, a general road, a street, or the like) the road width, and the road administrator (a nation, a prefecture, a local municipality, a public road administrator, or the like) A road with a higher road level tends to have a larger scale. For example, a link of the prefectural road and a link of the prefectural road have a same road level. The road level of a link of the national road is a higher than that of a link of the street.

The selecting unit 14 compares the road levels of adjacent links at each branch point detected by the branch point detecting unit 12. As a result of the comparison, the selecting unit 14 selects a branch point at which the road level of the link farther from the vehicle is equal to or higher than that of the link closer to the vehicle. In other words, when the road level is unchanged or raised as the vehicle travels through a branch point where links are connected, the branch point is selected as the guide point. Specifically, when the vehicle is traveling on a link of the prefectural road, the selecting section 14 selects as the guide point a branch point to which the prefectural road, national highway, or toll road is connected.

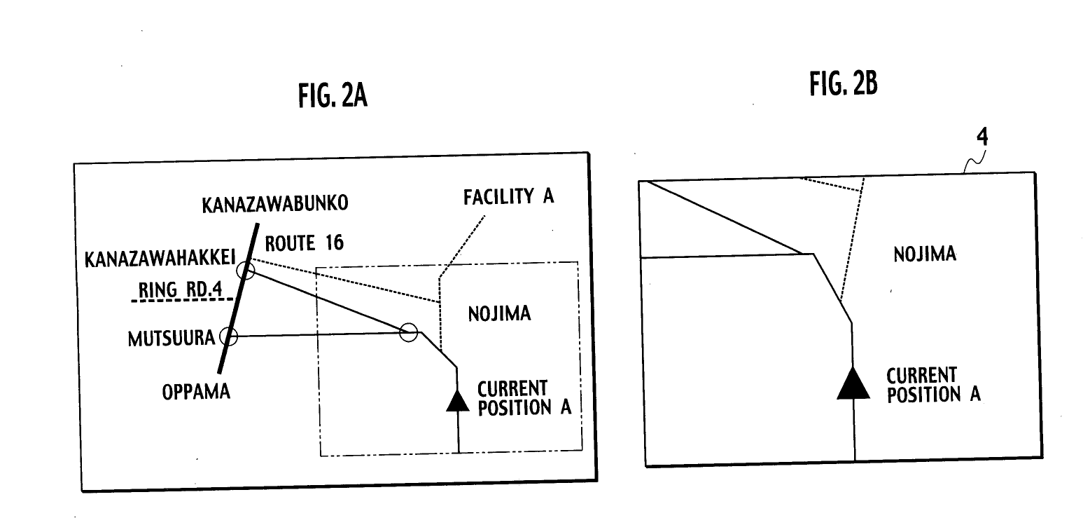

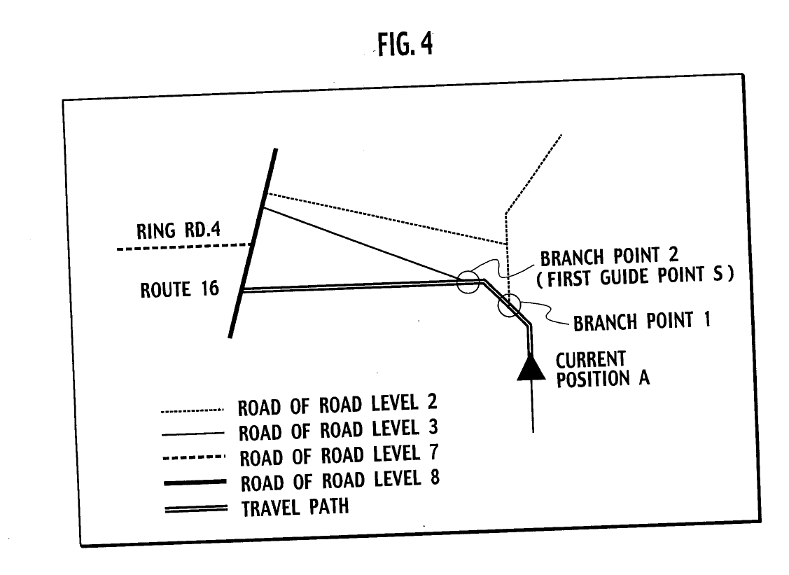

Herein, a description is given of a process by the guide point selecting section 1 to select the guide point based on the drawings. For a specific description, a case where the vehicle is located at a current position A shown in FIG. 2A is taken as an example. When the vehicle is located at the current position A shown in FIG. 2A, the map information shown in FIG. 2B is displayed on the display section 4. The guide point selecting section 1 selects a guide point whose branch destination information is to be displayed. FIG. 4 shows a guide point S selected when the vehicle is located at the current position A of FIG. 2A. The guide point is one of predetermined branch points located on the travel path calculated by the travel path calculating section 12.

The travel path which is calculated in the example is a road indicated by a double line. The guide point selecting section 1 detects a road having a road level equal to or higher than the road level (level 3, see FIG. 4) of the travel path from the vehicle's current position. At a first branch point 1, the travel path intersects a road with a road level (level 2) lower than the road level (level 3) of the travel path. The selecting unit 14 does not select the first branch point as the guide point. At a next branch point 2, the path intersects a road with a load level (3) same as that of the travel path. The selecting unit 14 then selects the branch point 2 as the guide point. The selecting section 14 sequentially determines at each branch point on the travel path in the travel direction whether the branch point is selected as the guide point.

The selecting unit 14 selects a branch point closest to the vehicle among the selected guide points as a first guide point. The selecting unit 14 selects a branch point second closest to the vehicle among the guide points as a second guide point. As the vehicle travels, the second guide point becomes the first guide point, and a guide point next closest to the vehicle becomes the second guide point.

The direction guide information generating section 2 includes a direction information acquiring unit 21, a traffic information acquiring unit 22, and a generating unit 23. The direction guide information generating section 2 generates the direction guide information of the guide point selected by the guide point selecting section 1. The direction guide information in this embodiment includes at least a place name of a branch destination of the guide point (branch point) on the travel path. A name of the road branching from a guide point may be included. The direction guide information of this embodiment is information including the current position of the vehicle, the travel path, facilities around the vehicle and the travel path, and the like which are displayed on a map.

The direction information acquiring unit 21 acquires the name of a branch destination of the guide point from the map information 51. The traffic information acquiring unit 22 acquires traffic information of a road including the guide point by use of FM multiplex or an optical beacon. The traffic information includes information concerning congestion, traffic regulations, constructions, and the like.

The generating unit 23 generates the direction guide information of the guide point using the acquired information. The generating unit 23 of this embodiment generates the direction guide information based on the map information, the vehicle's position, the travel path, the branch destination at the guide point, the name of the road branching from the guide point, and the traffic information. The generating unit 21 of this embodiment especially generates the direction guide information in which the guide point on the travel path is associated with display of the place name of the branch destination at the guide point.

Specifically, the generating unit 23 generates the direction guide information in which the place name of the branch destination is displayed near the corresponding guide point (branch point). The generating unit 23 also generates the direction guide information in which the place name of the branch destination is displayed near the road branching from the guide point (branch point). It is thus possible to generate the direction guide information exhibiting the association between the guide point (or branching road) and the place name of the branch destination. In other words, the user can visually check easily which branch point's destination or which road's destination is related to the branch destination displayed in the direction guide information. If a branch point and a branch destination at the branch point are presented without being associated with each other, it is difficult for the user to determine which branch point's destination the displayed branch destination is. Moreover, it is difficult for the user to understand the geographical relationship between the branch point and the branch destination especially in a place where the user does not know his/her way. In this embodiment, since the direction guide information in which the branch point is associated with the branch destination thereof, the user can easily understand which branch point's information the displayed direction of the branch destination is. The user can thus understand an accurate geographical position of the destination guided by the direction guide information.

Furthermore, the generating unit 23 generates the direction guide information in which the road from the vehicle's current position to the guide point selected by the guide point selecting section and the road branching from the guide point are highlighted. The method of highlighting is not particularly limited, and in this embodiment, forms of displaying a highlighted road, such as a color and a width, are made different from those of the other part. This makes clear the positional relationship between the vehicle and the guide point, and the user can accurately recognize the branch destination.

The generating unit 23 of this embodiment generates the direction guide information including at least information on congestion on a road through the guide point among the traffic information which the traffic information acquiring unit 22 acquires, such as congestion information, traffic regulation information, and construction information. In the case of displaying congestion information on another road, it is preferable that the congestion information on the road through the guide point is more highlighted than the congestion information on another road. The traffic information on the road through the guide point is included in the direction guide information or highlighted, thus enabling the user to easily understand traffic information at the branch destination. Therefore, the user can select a route avoiding congestion and the like based on the location of the branch point and the branch destination.

The display controlling section 3 controls outputting the generated direction guide information. The display controlling section 3 of this embodiment controls display timing, image rotation, scrolling display, and contrast display. The display controlling section 3 makes a control so that the direction guide information is presented when the distance between the vehicle's position and the first guide point is reduced to a predetermined value or less, that is, when the vehicle approaches the first guide point. Therefore, the direction guide information of the first guide point can be presented when the driver needs information on the first guide point.

Preferably, the distance between the vehicle and the first guide point which is the basis for determining when to display the direction guide information is individually determined based on the attribute information such as predicted travel speed and the presence of right and left turn lanes. This is because the driver tends to require the information on the branch destination earlier on a highway or toll road where the vehicle travels at high speed or on a road including a right or left turn lane which requires a lane change decision.

The display controlling section 3 of this embodiment controls rotation of an image so that the direction that the vehicle proceeds to the first guide point is directed upward and presents the direction guide information at least until the vehicle passed the first point. This enables the driver to easily recognize the relationship between the vehicle's travel direction and the first guide point. The display controlling section 3 of this embodiment stops a scrolling function when the distance between the vehicle's position and the first guide point is reduced to a predetermined value or less, that is, when the vehicle approaches the first guide point. The map is designed not to scroll when the vehicle approaches and passes the first guide point, which enables the driver to accurately recognize the direction guide information.

The display controlling section 3 of this embodiment presents images of the road from the vehicle's position to the first guide point and the road branching from the first guide point with a different contrast from that of the image of the other part. The driver can thus accurately recognize the positional relationship between the vehicle and the first guide point and the direction of the road branching from the first guide point. Therefore, the driver can roughly understand road information based on the first guide point.

The display controlling section 3 of this embodiment changes the scale of the image of the direction guide information so that the direction guide information including the first and second guide points can be presented on a display of the display section 4. The driver can obtain the information on the branch points of the first and second guide points on a screen and can operate the vehicle at the first guide point in consideration of the branch destination of the second guide point.

The display section 4 is a display or the like for displaying image information corresponding to the direction guide information. The display section 4 presents the direction guide information according to the output control by the display controlling section 3.

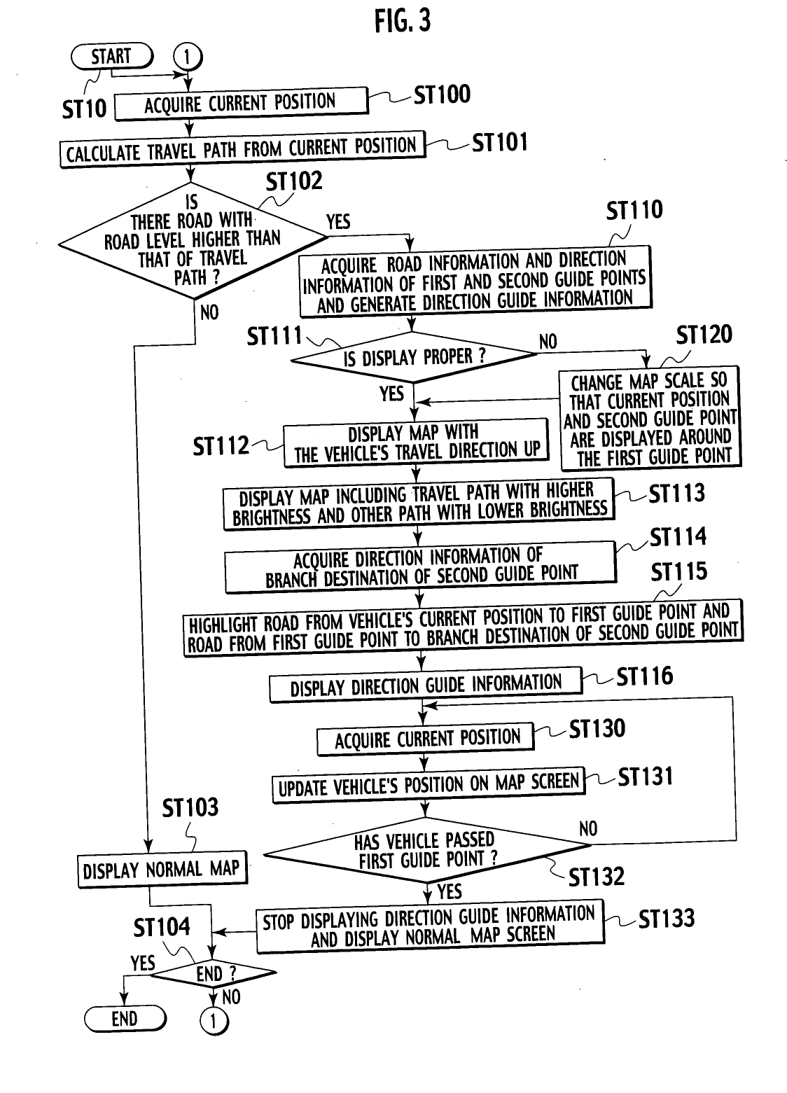

Next, a description is given of a control procedure of the navigation device 100 as the first embodiment of the present invention with reference to a flowchart of FIG. 3. Herein, a control procedure for presentation of the direction guide information of the navigation device 100 is mainly described.

In step ST10, a function to display the direction guide information starts to operate. The navigation device 100 displays normal map information until display of the direction guide information is executed.

The vehicle position detecting function 121 of the travel path calculating unit 12 acquires the vehicle's current position by using a GPS (Global Positioning System) function or the like, and the map information acquiring unit 11 accesses the storage section 5 and acquires necessary information from the map information 51 (ST100).

The travel path calculating unit 12 calculates the travel path. The path calculating unit 12 presumes a road satisfying at least any one of the following conditions to be the travel path: a road in which adjacent links have similar identification information; a road in which the adjacent links have similar attribute information; and a road in which the connection angle of the adjacent links are not less than a predetermined value (ST101).

The branch point detecting unit 13 acquires at least information concerning a road as long as a predetermined distance from the vehicle's current position in the calculated travel path. The branch point detecting unit 13 detects branch points (nodes) on the calculated travel path as candidates for the guide points.

The selecting unit 14 acquires the road levels concerning the road scale, which are previously associated with links constituting roads included in the map information. The selecting unit 14 compares the road levels of adjacent links at each of the detected branch points and judges whether the road level of the link farther from the vehicle is not lower than that of the link closer to the vehicle, that is, whether the travel path is connected to a road having a road level not lower than that of the travel path (ST102). The road level of this embodiment is an indicator determined based on the road scale and road administrator. A road which has a larger scale (the number of lanes, road width, and length) and whose administrator organization is larger (for example, the road level of the national highway is higher than that of the prefectural road) has a higher value (load level).

When there is a branch point at which the travel path is connected to a road with a road level not lower than that of the travel path, the procedure proceeds to step ST110. Otherwise, normal map information (or route guide information) is presented. In step ST110, the selecting unit 14 selects the branch point closest to the vehicle as the first guide point and the branch point second closest to the vehicle as the second guide point among the branch points at which roads with a road level not lower than that of the travel path is connected to (branches from) the travel path. When the detected second guide point is a dead end or not located within a predetermined distance from the current position, the selecting unit 14 sets the dead end or the point the predetermined distance apart from the current position to be the second guide point.

FIG. 4 shows the selected first guide point when the vehicle is located at the current position of FIG. 2A. The first guide point is located on the travel path calculated by the travel path calculating unit 12. In this embodiment, the travel path is calculated based on the identification information, attribute information, and connection angle of links. The calculated travel path is indicated by a double line. Subsequently, the guide point selecting section 1 searches for a road having a road level equal to or higher than the road level (level 3, see FIG. 2A) of the travel path from the vehicle's current position. At the first branch point 1, the travel path intersects the road having a road level (level 2) lower than the road level (level 3) of the travel path. At the next branch point 2, the path intersects the road having a road level (level 3) equal to that of the travel path. The selecting unit 13 selects the branch point 2 as the first guide point S.

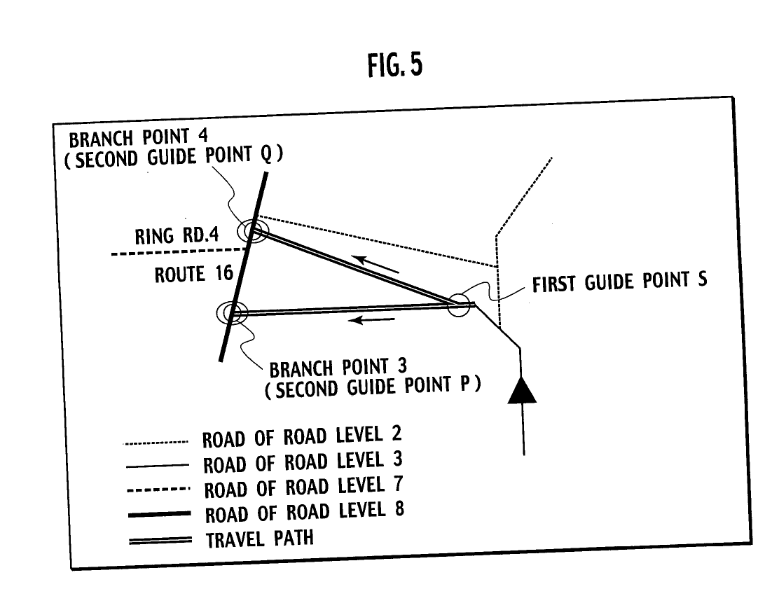

FIG. 5 shows the selected second guide points when the vehicle is located at the current position of FIG. 2A. The selecting unit 14 searches for a point at which each road connecting to the first guide point S is connected to a road with a road level equal to or higher than the road level (level 3) thereof. As shown in FIG. 5, the branch points 3 and 4 are candidates in this example. The selecting unit 14 sets the branch point closest to the first guide point S to be the second guide point among the searched branch points. In this example, the distances from the first guide point S to the branch points 3 and 4 are substantially the same (the difference between the distances is not more than a predetermined value), and the selecting unit 14 selects both the branch points 3 and 4 as second guide points P and Q.

The direction guide information acquiring unit 21 of the direction guide information generating section 2 acquires road information including locations of the first and second guide points and direction information including the place names of the branch destinations of the first and second guide points from the map information 51, and the generating unit 23 generates the direction guide information (ST110).

The display controlling section 3 judges whether display of the direction guide information is proper (ST111). Specifically, the display controlling section 3 judges whether the direction guide information displayed on a display area of a display 4 includes the first guide point displayed in the center and further includes the vehicle's current position and the second guide point. When the display is proper, the procedure proceeds to step ST112. On the contrary, when the display is not proper, the procedure proceeds to step ST120. In the step ST120, the display controlling section 3 changes the scale of the map included in the direction guide information so that the direction guide information including the first and second guide points can be displayed in the display area of the display (display section) 4. In this embodiment, the scale of the map included in the direction guide information is changed so that the first guide point is displayed in the center of the display area of the display 4 and the second guide point and the vehicle's position are displayed within the display area. The procedure proceeds to step ST112 via this processing.

In the step ST112, the display controlling section 3 presents the direction guide information so that the direction that the vehicle proceeds into the first guide point is directed upward until the vehicle has passed the fist guide point. The display controlling section 3 presents images of the road from the vehicle's position to the first guide point and the road branching from the first guide point with a different contrast from that of the image of the other part. In this embodiment, the display controlling section 3 presents map information in which the brightness of the images of the road from the vehicle's position to the first guide point and the road branching from the first guide point is increased and the brightness of images of the other parts is reduced (ST113).

The direction guide information generating section 2 acquires the direction information of the branch destinations of the second guide points sequentially (ST114). It is preferable that the direction information of the branch destinations is related to a region displayed near the boundary of the display area of the display 4. When the vehicle passes the first guide point, the second guide point becomes the first guide point.

In step ST115, the display controlling section 3 highlights the road from the vehicle's current position to the first guide point, the road from the first guide point to each of the second guide points, and the road branching from each second guide point, that is, displays the same with higher brightness than that of the other part. In the case where the direction guide information is designed to include traffic information, the traffic information of the highlighted roads is highlighted.

In step ST116, the display controlling section 3 displays the generated direction guide information on the display 4. In this embodiment, the display controlling section 3 displays the direction guide information when the distance between the vehicle's position and the first guide point is reduced to a predetermined value or less. In the generated direction guide information, the branch destinations of the travel path are associated with displays of the place names of the branch destinations. In addition, the road from the vehicle's current position to the first guide point, the road from the first guide point to the second guide point, and the road branching from the second guide point are highlighted in the direction guide information of this embodiment. Furthermore, the direction guide information includes traffic information of the road from the first guide point through the second guide point, which the traffic information acquiring unit 22 acquired. In the direction display of each second guide point, a name of a place located near the boundary of an area which can be displayed in the display 4 is displayed. As information guiding the direction, a landmark name may be displayed in addition to the place name. The generating unit 23 of the direction guide information generating section 2 acquires the names of the roads branching from the first and second guide points and displays the roads and the names such that the roads correspond to the names. In this case, it is preferable that the name of each road is displayed in the middle of the road displayed in the display area of the display 4. Moreover, it is preferable to remove one of the redundant displays from the direction guide information to avoid confusion.

The guide point selecting section 1 acquires the vehicle's current position and selects the first and second guide points which change with a change in the vehicle's current position (ST130). The direction guide information generating section 2 generates the direction guide information reflecting the acquired vehicle's current position. Until the selecting unit 13 changes the first guide point, the map information around the first guide point is not updated to be displayed, and the current position and the travel direction of the moving vehicle are displayed on this map information (ST131).

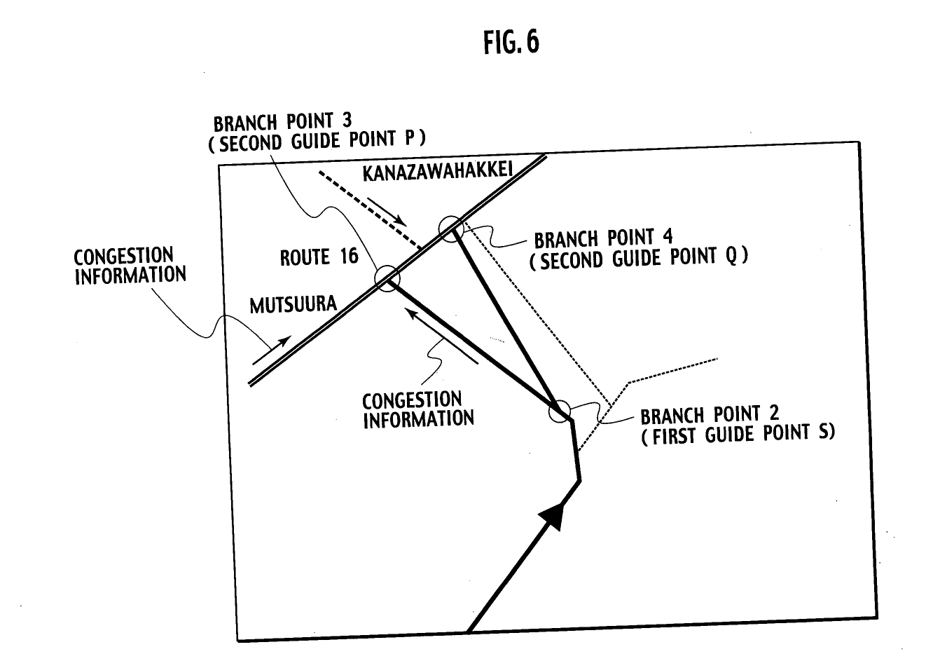

FIG. 6 shows a display example of the direction guide information. As shown in FIG. 6, the map scale is changed so that the first guide point is shown in the center of the display area of the display 4 and the vehicle's current position and the second guide point are shown within the display area of the display 4. This direction guide information is displayed so that the direction that the vehicle proceeds into the first guide point is directed upward. In addition, the road from the current position to the first guide point, the road from the first guide point to the second guide point, and the road branching from the second guide point are more highlighted than the other part of the map image. As the method of highlighting, a method of giving a contrast by increasing the brightness of a road desired to be highlighted is used. The direction guide information of this example is displayed with the traffic information acquired by the traffic information acquiring unit 22. In the direction guide information of this example, a place name or facility name indicating the branch destination of each second guide point is displayed near the corresponding road. The displayed place or facility names are located near the boundary of the display area of the display 4.

In step ST132, the display controlling section 3 judges whether the vehicle has passed the first guide point. The direction guide information generating section 2 continues the acquisition of the vehicle's current position (ST130) until the vehicle has passed the first guide point. When judging that the vehicle has passed the first guide point (ST132: YES), the display controlling unit 3 stops displaying the direction guide information and restores a route guide display which has been displayed until the direction guide information is presented. The control instructions related to the scale for displaying the direction guide information, the object displayed in the center of the display area (first guide point), and the display mode (for example, heading up) are terminated (ST133).

In step ST104, when an engine is turned off or the navigation device 100 is turned off, the process is terminated. Otherwise, the procedure proceeds to the step ST100.

The navigation device 100 as the first embodiment of the present invention is constructed and operates as described above and has the following effects. In this embodiment, the description has been given of the navigation device 100, but a navigation program of the present invention executed by a computer operates in the same manner and has the same effects as the navigation device 100.

Since the navigation device 100 generates the direction guide information in which the selected guide point is associated with the branch destination thereof, the driver can accurately recognize the location of the branch point and the direction of the branch destination of the branch point when the vehicle approaches the branch point. Therefore, the driver can easily know, with respect to the current position, without setting a route where each road branching from each branch point leads. Even in a place which the driver does not know his/her way, the driver can accurately recognize the geographical position of a destination guided by the direction guide information. In addition, generating the direction guide information in which the place name of the branch destination is generated near the guide point or the road branching from the guide point allows the driver to accurately recognize the branch destination.

The navigation device 100 generates the direction guide information in which the road from the vehicle's current position to the guide point and the road branching from the guide point are highlighted. Therefore, the driver can accurately recognize the relative positional relationship between the current position and the guide point and can easily understand an overview of roads with respect to the guide point.

The navigation device 100 generates the direction guide information including traffic information of a road through the guide point. Therefore, the driver can determine a control of the vehicle at the branch point in consideration of the traffic information such as congested states, traffic regulations, and constructions. For example, the driver can avoid congestion and selects an uncongested path.

The navigation device 100 calculates the travel path based on the map information and the vehicle's current position and selects the guide point among branch points on the calculated travel path. It is then possible to guide the branch destination of the branch point on the path where it is calculated that the vehicle is highly likely to travel. Therefore, the driver can easily know with respect to the current position, without setting a route, where each road branching from each branch point leads. In other words, it is possible to provide necessary information for the driver at the position where the driver needs the information.

The travel path calculating unit 12 predicts the travel path based on at least any one of whether links constituting the travel path have the same identification information, whether the links have the same attribution information, and the connection angle of the links and can accurately calculate the travel path.

The road levels of links constituting the travel path are compared, and the branch point in which the road level of the link farther from the vehicle is not lower than that of the link closer to the vehicle is selected. The direction guide information can be thereby displayed at major branch points on the travel path. Therefore, it is possible to provide necessary information for the driver at a position where the driver needs the information.

The guide point closest to the vehicle among the selected guide points is set as the first guide point, and the direction guide information can be thereby presented at a major branch point which the vehicle approaches first. Therefore, it is possible to provide necessary information for the driver at a position where the driver needs the information.

Among the selected guide points, the guide point second closest to the vehicle is set as the second guide point, and the direction guide information can be thereby presented at the major branch points which the vehicle approaches first and which the vehicle approaches next. When there are a plurality of routes reaching a same destination (for example, in FIG. 4, there are a plurality of routes to Ring Road 4), therefore, a proper route, such as an uncongested route or a short route, can be selected among a plurality of routes.

The navigation device 100 presents the direction guide information when the distance between the vehicle's position and the first guide point is reduced to a predetermined value or less, that is, when the vehicle approaches the first guide point. Therefore, it is possible to provide necessary information for the driver at a position where the driver needs the information.

The navigation device 100 presents the direction guide information until the vehicle has passed the first guide point so that the direction that the vehicle proceeds into the first guide point is directed upward. Therefore, the navigation device 100 can output the direction guide information from which the driver can easily recognize the direction of the road branching from the branch point. Especially when the guide point is located after a curve, the driver can easily imagine in advance which direction the driver should turn at the guide point.

The navigation device 100 stops the scrolling function when the distance between the vehicle's position and the first guide point is reduced to a predetermined value or less, and the navigation device 100 can thereby present information including the place names in the direction guides in a way easy to read.

The navigation device 100 displays the road from the vehicle's position to the first guide point and the road branching from the first guide point with a contrast different from that of the image of the other part. Therefore, the navigation device 100 can output the direction guide information from which the driver can easily understand rough geographical information.

Similarly, the navigation device 100 displays the road from the vehicle's position to the first guide point, the road from the first guide point to the second guide point, and the road branching from the second guide point at a contrast different from that of the image of the other part. Therefore, the navigation device 100 can output the direction guide information from which the driver can easily understand rough geographical information.

The navigation device 100 is designed to present the direction guide information including the first and second guide points by means of the display section 4 by changing the scale of the direction guide information. Therefore, the navigation device 100 can output the direction guide information from which the relative positional relationship among the vehicle's position and the first and second guide points is easy to understand.

### Second Embodiment

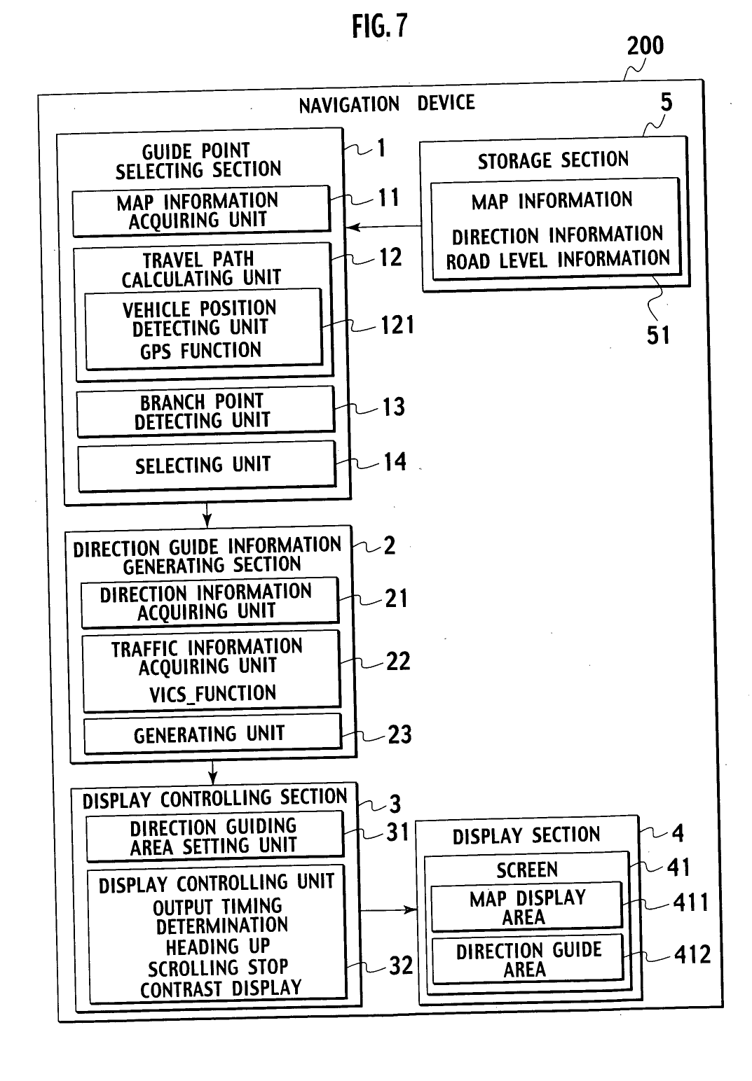

A navigation device 200 as a second embodiment of the present invention is different from the navigation device 100 as the first embodiment in configurations of the selecting unit 14, direction guide information generating section 2, display controlling section 3, and display section 4. Hereinafter, a description is given of only the selecting unit 14, direction guide information generating section 2, display controlling section 3, and display section 4 with reference to FIG. 7, and a description of the other components is omitted.

The selecting unit 14 of this embodiment sets first and second map areas in the map information. The first map area corresponds to a display area of a screen 41 of the display section 4, and the second map area includes the first map area. Among the selected guide points, the selecting unit 14 selects a guide point included in the first map area as the first guide point and selects a guide point not included in the first map area but included in the second map area as the second guide point.

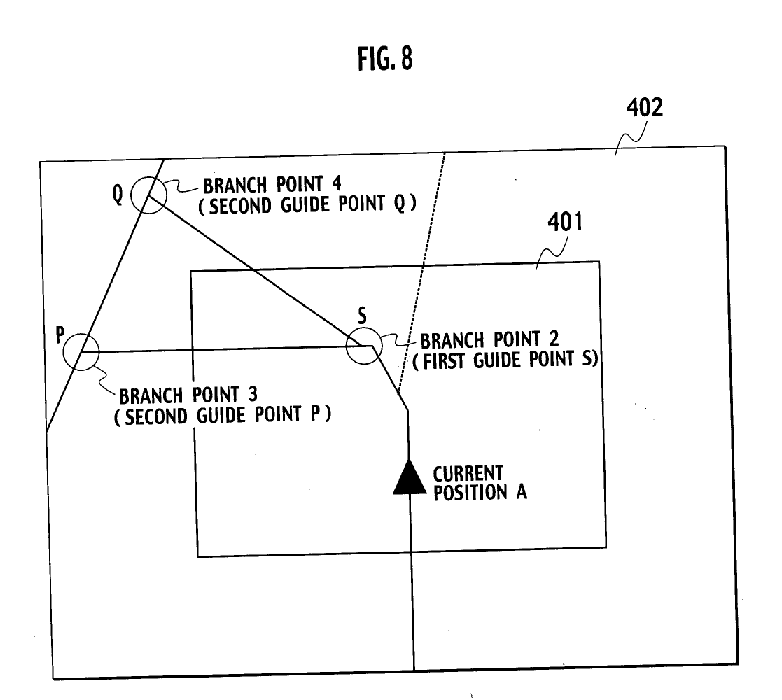

FIG. 8 shows a first map area 401, a second map area 402, a first guide point S, and second guide points P, Q. The second guide points P, Q are the guide points on roads branching off from the first guide point S, which are included in the respective calculated travel paths. The first map area 401 of this example has a same shape as the screen 41. In other words, the first map area 401 corresponds to the area of the map information which can be displayed on the screen 41. The first guide point S is the guide point included in the first map area among the selected guide points.

The second guide points P, Q are the guide points not included in the first map area and included in the second map area among the selected guide points. In other words, the first guide point is a branch point included in the map information displayed on the display section 4 while the second guide points are branch points included in map information not displayed on the display section 4. When a plurality of the first guide points are selected, processing may be performed by setting each guide point as the first guide point, or a branch point closest to the vehicle may be selected as the first guide point among the guide points. Also for the second guide points, processing may be performed by setting each of the plurality of selected branch points as the second guide point, or the processing may be performed by setting a branch point closest to the vehicle as the second guide point among the selected branch point candidates.

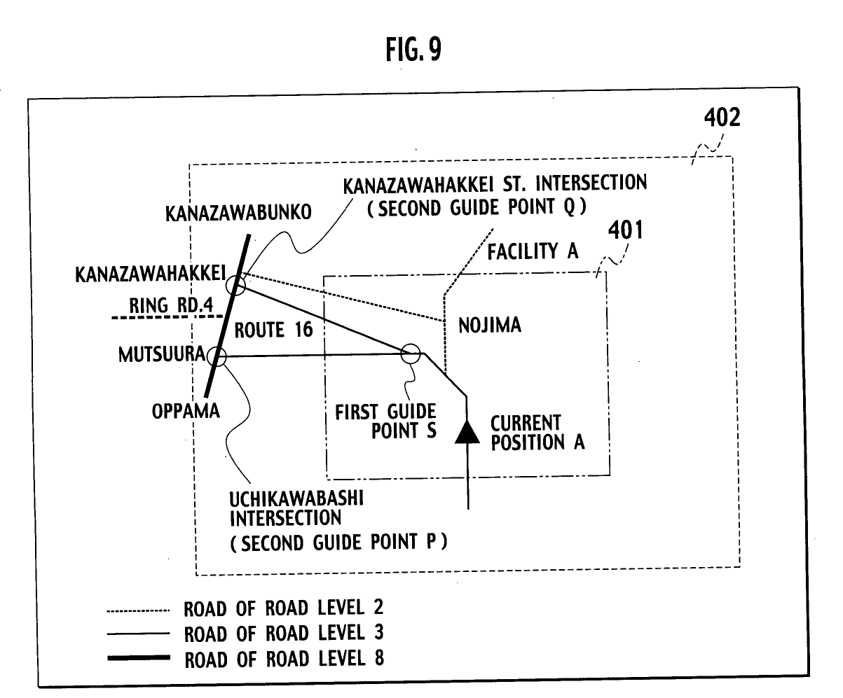

FIG. 9 shows a positional relationship among selected first guide point S, selected second guide point P, Q, and the current position A. The first and second map areas change as the vehicle travels, and the first and second guide points are updated accordingly.

The direction guide information generating section 2 includes the direction information acquiring unit 21, the traffic information acquiring unit 22, and the generating unit 23 and generates the direction guide information including the place name of a branch destination of a guide point located outside of the map information displayed on the screen 41 of the display section 4. Specifically, the direction guide information in this embodiment includes at least place names of destinations of roads branching off from the selected second guide points, which are previously described. Preferably, this direction guide information includes names of the roads branching off from the second guide points, a schematic view of the roads branching off from the second guide point, a connection relationship between the second guide point and the road from the first guide point to the second guide point, or traffic information of the roads branching off from the second guide point.

The direction information acquiring unit 21 acquires the place names of the destinations of the roads branching off from the second guide point (branch point) and the names of the roads branching off from the second guide point (branch point). The traffic information acquiring unit 22 acquires traffic information of the roads branching off from the second guide point by use of FM multiplex or an optical beacon. The traffic information acquiring unit 22 may certainly acquire traffic information of the road including the first guide point, the road including the second guide point, and the other roads of the travel path. The traffic information includes traffic congestion information, traffic regulation information, construction information, and the like.

The generating unit 23 generates the direction guide information of the guide point by using the acquired information. The generating unit 23 of this embodiment generates the direction guide information including the place names of the destinations of the roads branching off from the second guide point and the names of the roads branching off from the second guide point. Each of the place names of the destinations is set to the name of a place a predetermined distance apart from the branch point. The generating unit 23 of this embodiment generates the direction guide information including a schematic view of the roads branching off from the second guide point. It is preferable that this schematic view of the roads indicates a connection relationship between the second guide point and the road from the first guide point to the second guide point.

The generating unit 23 of this embodiment generates direction guide information including a branch point corresponding to the second guide point and the schematic road view showing the roads branching off from the branch point. The navigation device 200 of this embodiment can thereby display the names of the branch destinations and the names of the branching roads for the second guide point which is not displayed on the map display screen. Therefore, the user can acquire the branch destination information (including place names of branch destinations, names of branching roads, and the connection relationship among the branching roads and the second guide point) for the branch point outside of the display range without a scrolling operation or an operation of scale change of the map information.

Moreover, the generating unit 23 generates direction guide information in which the road from the vehicle's current position to the first guide point selected by the guide point selecting section 1 and the road branching from the first guide point (road reaching the second guide point) are highlighted. The method of highlighting is not particularly limited, and in this example, forms of displaying a road to be highlighted, such as a color and a width, are made different from those of the other part. The user can thereby accurately recognize the positional relationship between the vehicle and the guide points.

The generating unit 23 of this embodiment generates the direction guide information including at least congestion information on roads through the guide points among the traffic information which the traffic information acquiring unit 22 acquires, such as congestion information, traffic regulation information, and construction information. The user can thereby easily understand the traffic information of the branch destinations. Therefore, the user can select a route avoiding congestion and the like based on the locations of the branch points and the branch destinations.

The display controlling section 3 includes a direction guide area setting unit 31 and a display controlling unit 32. The display controlling section 3 sets a “direction guide area” for displaying the generated direction guide information on the screen 41 and displays the direction guide information in the set direction guide area. The display controlling section 3 sets a map display area for displaying the map information on the screen 41 and displays the map information in the set map display area. The display controlling section 3 controls setting, switching, and displaying the direction guide area and the map display area on the screen 41.

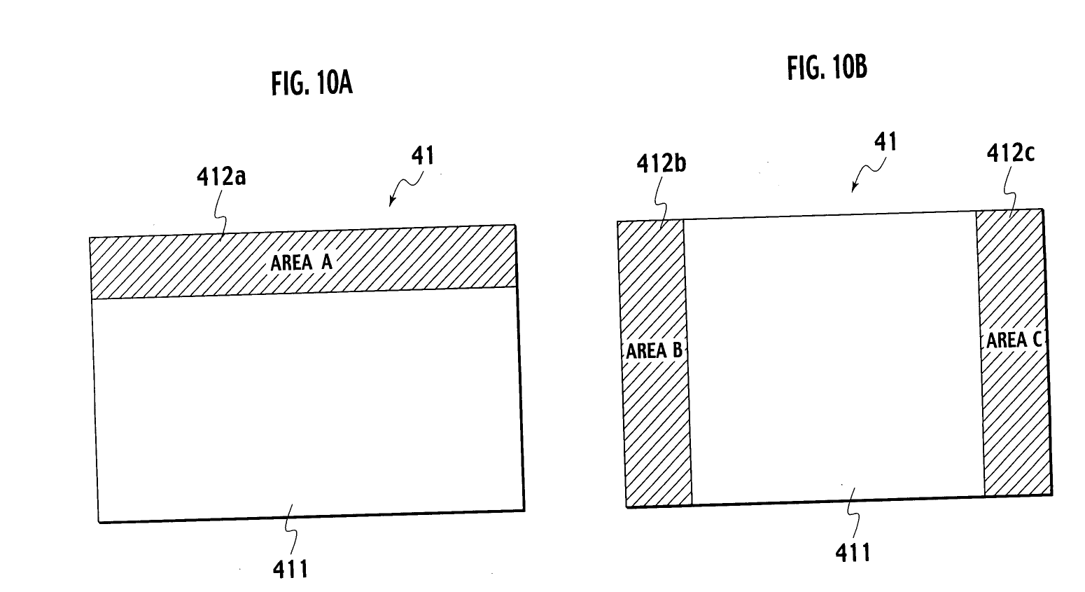

The display control section 3 of this embodiment sets at least a direction guide area along the edge of the screen 41. FIGS. 10A and 10B show the direction guide area of this embodiment. An area A shown in FIG. 10A is a direction guide area 412a provided in the upper edge of the screen. An area B shown in FIG. 10B is a direction guide area 412b provided in the left edge of the screen, and an area C shown in FIG. 10B is a direction guide area 412c provided in the right edge of the screen. The direction guide area is not necessarily always set, and preferably, the direction guide area is set when the direction guide information to be displayed is generated. The direction guide area can be set by a single area A, B, or C or can be set by a combination of the areas A and B, the areas A and C, or the areas B and C. The display controlling section 3 sets an area other than the direction guide area as the map display area.

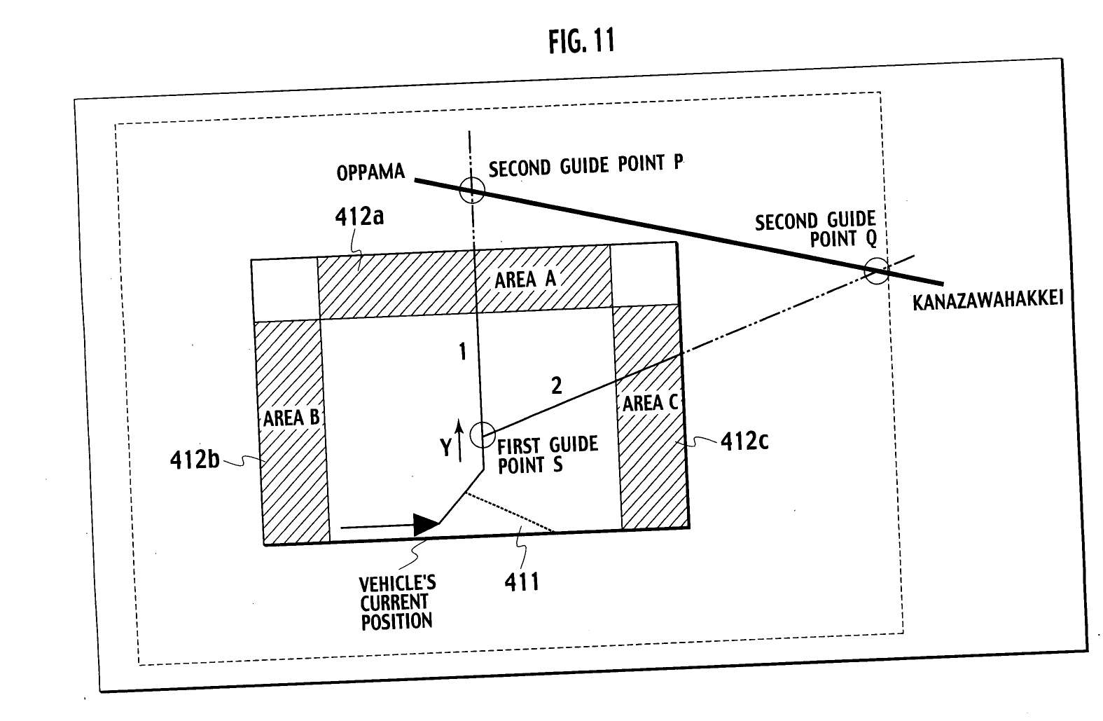

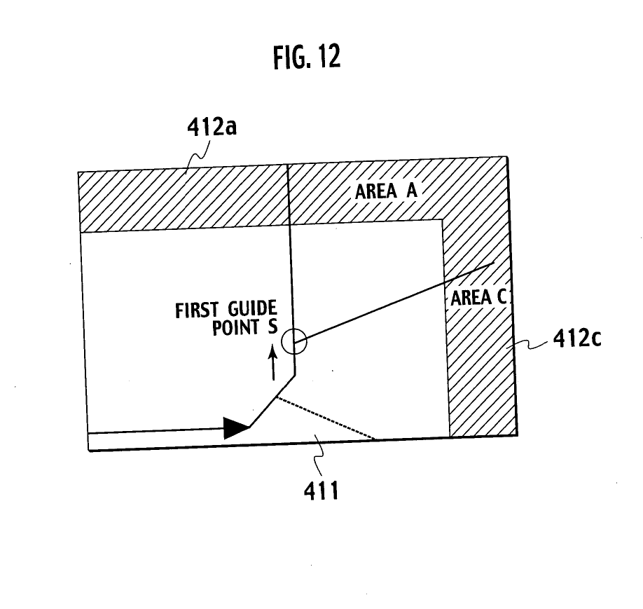

The display controlling section 3 of this embodiment displays the direction guide information related to branch destinations of the second guide point in the predetermined direction guide area according to the positional relationship between the first and second guide points. In this embodiment, on the screen 41 with the origin set to the first guide point and an axis Y set in the direction that the vehicle proceeds into the first guide point, the direction guide information of the second guide point is displayed in the direction guide area (412a, 412b, or 412c) passed by the travel path branching from the first guide point toward the second guide point. A specific description thereof is given based on FIG. 11. The vehicle heads toward a first guide point S from the current position. Herein, the first guide point is set as the origin, and the direction that the vehicle proceeds into the first guide point is set upward, which is the axis Y. The travel paths branching off from the first guide point extend toward second guide points P and Q. A travel path 1 toward the second guide point P passes the area A. In this case, the display controlling section 3 displays the direction guide information related to the branch destinations of the second guide point P in the area A. A travel path 2 toward the second guide point Q passes the area C. In this case, the display controlling section 3 displays the direction guide information related to the branch destinations of the second guide point Q in the area C. Thus, the direction of the second guide point with respect to the first guide point matches the direction of the direction guide area with respect to the first guide point on the screen. In other words, the information of the branch destinations of the second guide point can be displayed in a direction of the second guide point with respect to the vehicle. The screen 41 displayed in the example is shown in FIG. 12. As shown in FIG. 12, the display controlling section 3 sets only the areas A and C passed by the travel paths as the direction guide area 412 and sets the other area of the screen as the map display area 411.

The display controlling section 3 of this embodiment displays the direction guide information when the distance between the vehicle's position and the first guide point is reduced to a predetermined value. Therefore, the direction guide information can be displayed when the first guide point is detected and the vehicle approaches the first guide point. In other words, the direction guide information can be displayed when the user needs the information on the first guide point. Preferably, the distance between the vehicle and the first guide point which is the basis for determining when to display the direction guide information is individually determined based on the attribute information such as predicted travel speed and the presence of right and left turn lanes. This is because the user tends to require the information on the branch destinations earlier on a highway or toll road where the vehicle travels at high speed or on a road including a right or left turn lane which requires a lane change decision.

The display controlling section 3 of this embodiment displays the travel position of the vehicle so that the direction that the vehicle proceeds into the first guide point is directed upward on the screen 41. Preferably, this display mode is maintained until the vehicle has passed the first guide point. This display example is shown in FIG. 12. FIG. 12 shows a display example of the case where the vehicle is located at the current position A shown in FIG. 2A. As shown in FIG. 12, the map information in which the direction that the vehicle proceeds into the first guide point is directed upward on the screen 41 is displayed.

The display controlling section 3 of this embodiment stops the scrolling function when the distance between the vehicle's position and the first guide point is reduced to a predetermined value or less and activates the scrolling function when the vehicle has passed the first guide point. The navigation device 200 of this embodiment includes the scrolling function to scroll the map information as the vehicle moves. The display controlling section 3 stops the scrolling function to fix the display range of the map information when the vehicle approaches within a predetermined distance from the first guide point. Therefore, a static image can be presented for the user in the vicinity of the branch points.

The display controlling section 3 displays images of the road from the vehicle's position to the first guide point and the road branching from the first guide point toward the second guide point at a different contrast from that of the image of the other part. The user can thereby accurately understand the positional relationship between the vehicle and the first guide point and the directions of the roads branching from the first guide point.

The display section 4 is a display device (for example, a display) including a screen having the direction guide area for displaying the direction guide information and the map display area for displaying the map information. The display section 4 displays the direction guide information and/or the map information according to the display control by the display controlling section 3.

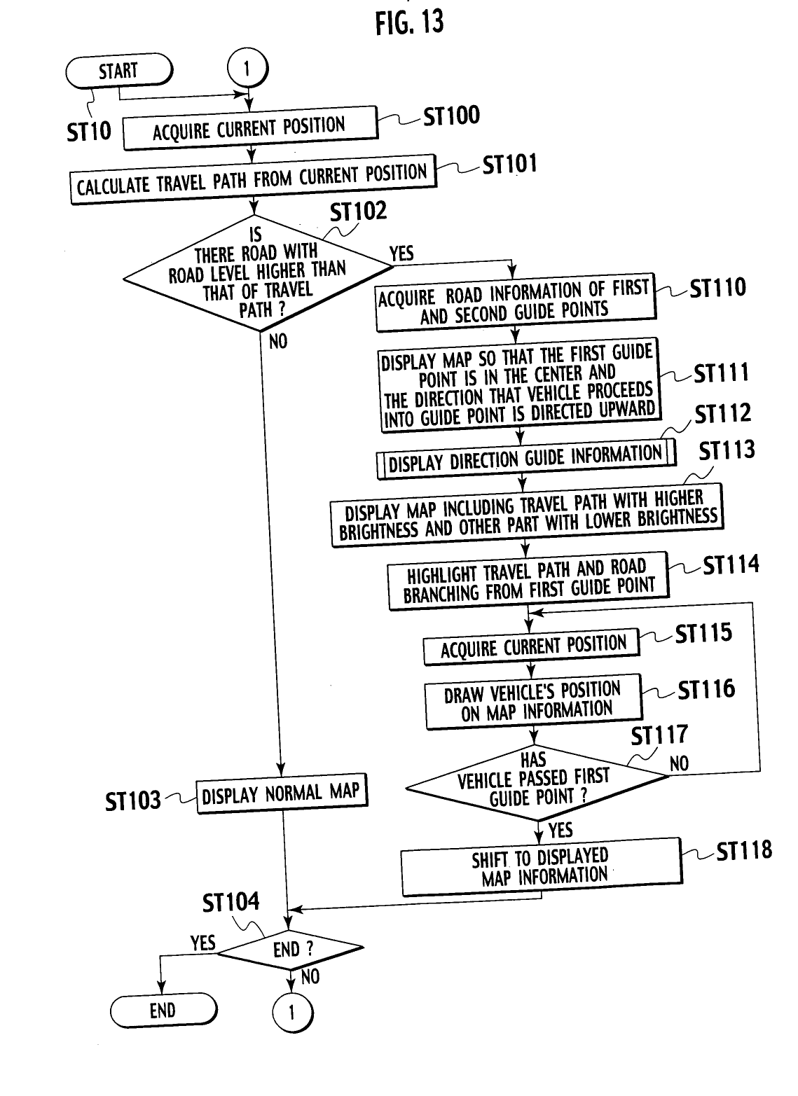

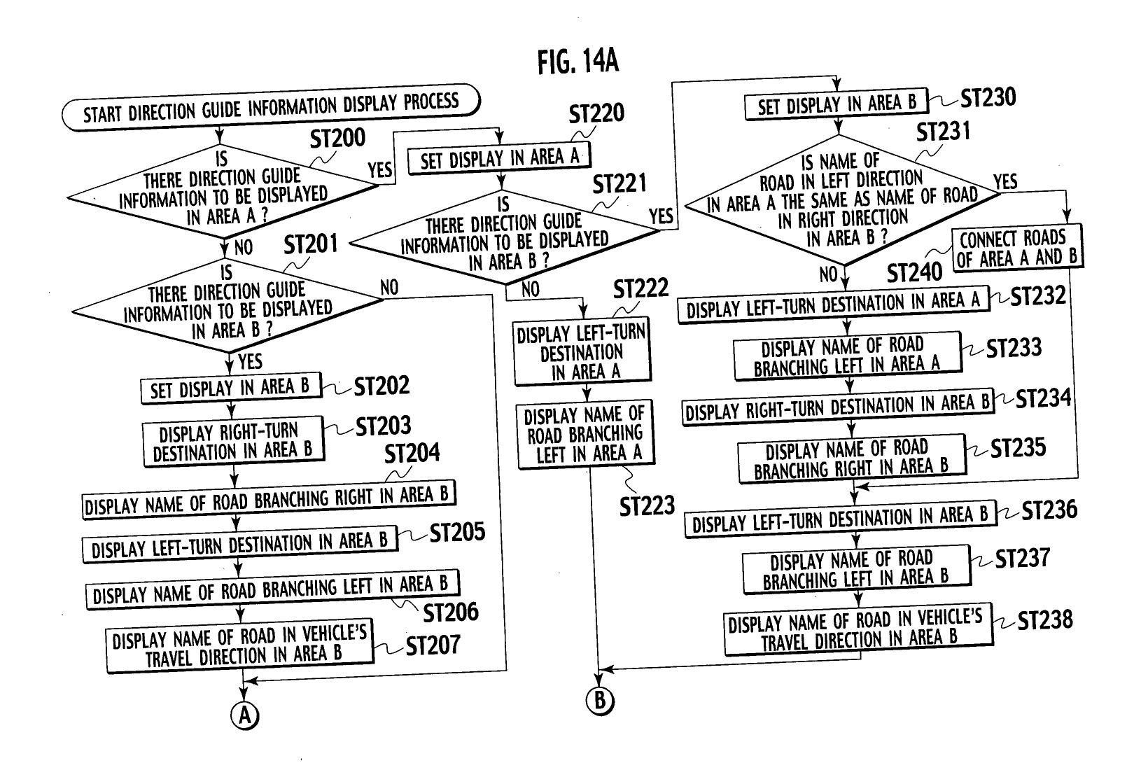

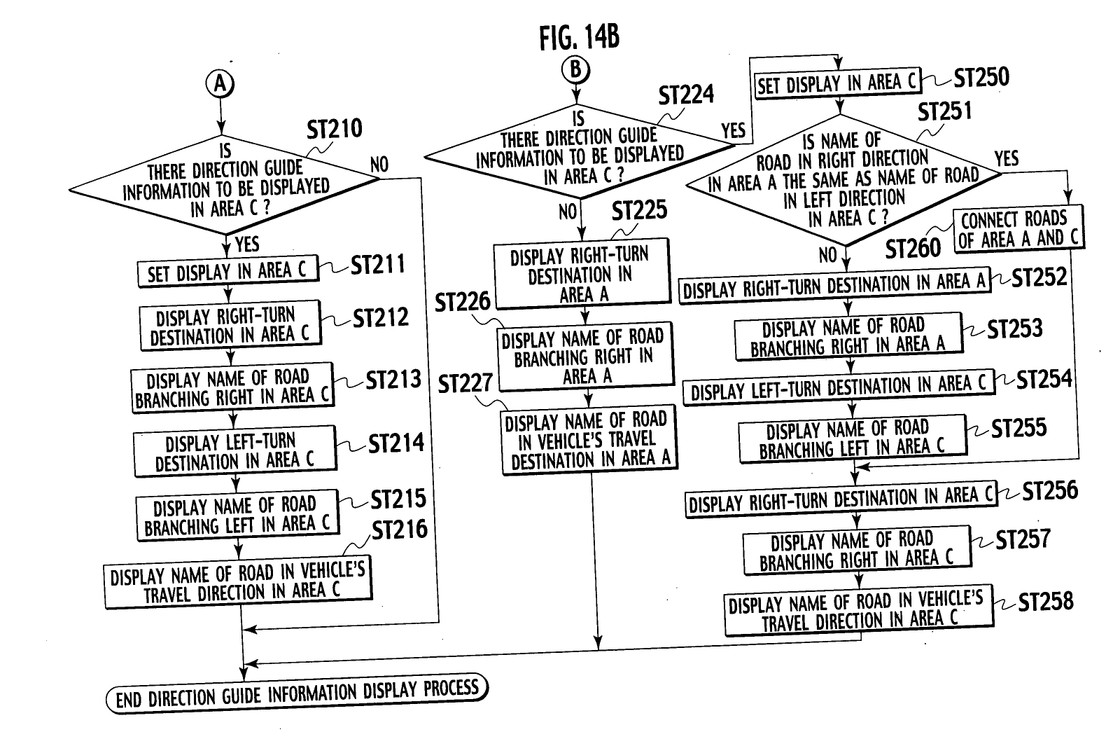

Next, a description is given of a control procedure of the navigation device 200 of this embodiment with reference to FIGS. 13 to 20. First, an entire flow of the control procedure is described based on a flowchart of FIG. 13, and a control procedure concerning display of the direction guide information is then described based on a flowchart of FIGS. 14A, 14B and FIGS. 15 to 20.

In step ST10, a function to display the direction guide information starts to operate. The navigation device 200 displays normal map information until the display of the direction guide information is executed. In this embodiment, route guide information in which the vehicle's position is shown on the map information is displayed.

The travel path calculating unit 12 acquires the vehicle's current position and acquires necessary information from the map information 51 by accessing the storage section 5 (ST100). The vehicle's current position is acquired by using the GPS function of the vehicle position detecting function 121 or the like.

The travel path calculating unit 12 calculates the travel path of the vehicle. The travel path calculating unit 12 presumes a road satisfying at least any one of the following conditions to be the travel path: a road in which adjacent links have similar identification information; a road in which the adjacent links have similar attribute information; and a road in which the connection angle of the adjacent links are not less than a predetermined value (ST101).

The branch point detecting unit 13 acquires at least information concerning a road as long as a predetermined distance from the vehicle's current position in the calculated travel path. The branch point detecting unit 13 detects branch points (nodes) on the calculated travel path as candidates for the guide points.

The selecting unit 14 selects a predetermined guide point whose direction guide information is to be displayed among the detected candidates. First, the selecting unit 14 acquires the road levels concerning the road scale, which are previously associated with links constituting roads included in the map information. The selecting unit 14 compares the road levels of adjacent links at the detected branch point and judges whether there is a branch point at which the road level of the link farther from the vehicle is not lower than that of the link closer to the vehicle, that is, whether the travel path is connected to a road having a road level not lower than the travel path (ST102). The road level of this embodiment is an indicator determined based on the road scale and road administrator. A road which has a larger scale (the number of lanes, road width, and length) and whose administrator organization is larger (for example, the road level of the national highway is higher than that of the prefectural road) has a higher value (load level).

When there is a branch point at which the travel path is connected to a road with a road level higher than that of the travel path, the procedure proceeds to step ST110. Otherwise, normal map information (or route guide information) is displayed (ST103). In the step ST110, the selecting unit 14 selects the first and second guide points among the branch points at which roads with road levels not lower than that of the travel path are connected to (branch from) the travel path. The selecting unit 14 sets the first map area corresponding to the display range displayed on the screen 41 and the second map area including the first map area in the map information. Among the selected branch points (guide points), the selecting unit 14 then selects the guide point included in the first map area as the first guide point and selects the guide point not included in the first map area and included in the second map area as the second guide point. In the case where a plurality of the branch points are selected as the first or second guide points, the branch point closest to the vehicle may be selected as the first or second guide point. When the detected second guide point is a dead end or not located within a predetermined distance from the current position, the dead end or the point the predetermined distance apart from the current position is selected as the second guide point.

The direction guide information acquiring unit 21 of the direction guide information generating section 2 acquires the road information including locations of the first and second guide points and the direction information including place names of branch destinations of the second guide point from the map information 51 (ST110).

The display controlling section 3 displays the map information (route guide information) in which the vehicle's travel position is indicated on the screen 41 so that the first guide point is displayed substantially in the center of the screen 41 and the direction that the vehicle proceeds into the first guide point is directed upward in the screen (see FIG. 12) (ST111). Preferably, this display mode is maintained at least until the vehicle has passed the first guide point. The scale of the displayed map information is a scale previously set or a scale specified by the user.

The display controlling section 3 sets the direction guide area for displaying the direction guide information on the screen and displays the direction guide information generated by the direction guide information generating section 2 (ST112). This process is described later.

The display controlling section 3 displays images of the road from the vehicle's position to the first guide point and the roads branching from the first guide point with a different contrast from that of the image of the other part. In this embodiment, the display controlling section 3 displays map information in which the brightness of the images of the road from the vehicle's position to the first guide point and the road branching from the first guide point is increased and the brightness of the image of the other part is reduced (ST113). The display controlling section 3 highlights the road from the vehicle's current position to the first guide point and the road from the first guide point to each of the second guide points. Forms of displaying a road to be highlighted, such as a color and a width, are made different from those of the other part (ST114). When there is traffic information concerning these roads, it is preferable to also highlight the traffic information thereof.

The guide point selecting section 1 acquires the vehicle's current position by use of the vehicle position detecting function 121 and selects the first and second guide points changing with a change in the vehicle's position (ST115). The acquired vehicle's position is drawn on the map information (ST116). The display controlling section 3 stops the scrolling function and displays the map information around the first guide point until the vehicle has passed the firs guide point after approaching within the predetermined distance from the first guide point (117). When the vehicle has passed the first guide point (ST117: YES), the display control means 3 stops the presentation of the display guide information and displays the map information displayed before the ST10 (ST118).

In ST104, when the engine is turned off or the navigation device 200 is turned off, the process is terminated. Otherwise, the procedure proceeds to the step ST100.

Next, the process to display the direction guide information is described based on the flowchart of FIGS. 14A, 14B.

The display controlling section 3 sets the direction guide area for displaying the generated direction guide information on the screen 41. As the direction guide area, the upper edge (area A), the right edge (area C), and the left edge (area B) of the screen 41 are set (see FIGS. 11 and 12). The display controlling unit 3 displays the direction guide information concerning the branch destinations of the second guide point in the predetermined direction guide area according to the relative positional relationship between the first and second guide points. In other words, in the screen 41 with the origin set to the first guide point and with the axis Y set in the direction that the vehicle proceeds into the first guide point, the display controlling section 3 displays the direction guide information of the second guide point in the direction guide area which the travel path branching from the first guide point to the second guide point.

The display controlling section 3 judges whether there is the direction guide information to be displayed in the set area A, that is, whether there is a travel path passing the area A (ST200). When there is no direction guide information to be displayed in the area. A (ST200: No), the procedure proceeds to ST201, and then the display controlling section 3 judges whether there is the direction guide information to be displayed in the set area A, that is, whether there is a travel path passing the area A (ST201). Herein, when the travel path branching from the first guide point does not pass the area B (ST201: No), the process proceeds to ST210.

A description is given of display control of the area B performed in the steps ST202 to ST207. The display controlling section 3 sets the direction guide area 412b along the left edge of the screen. In this example, the rectangular direction guide area 412b shown in FIGS. 10 to 12 is set. The set direction guide area 412b can be controlled independently of the display of the other part.

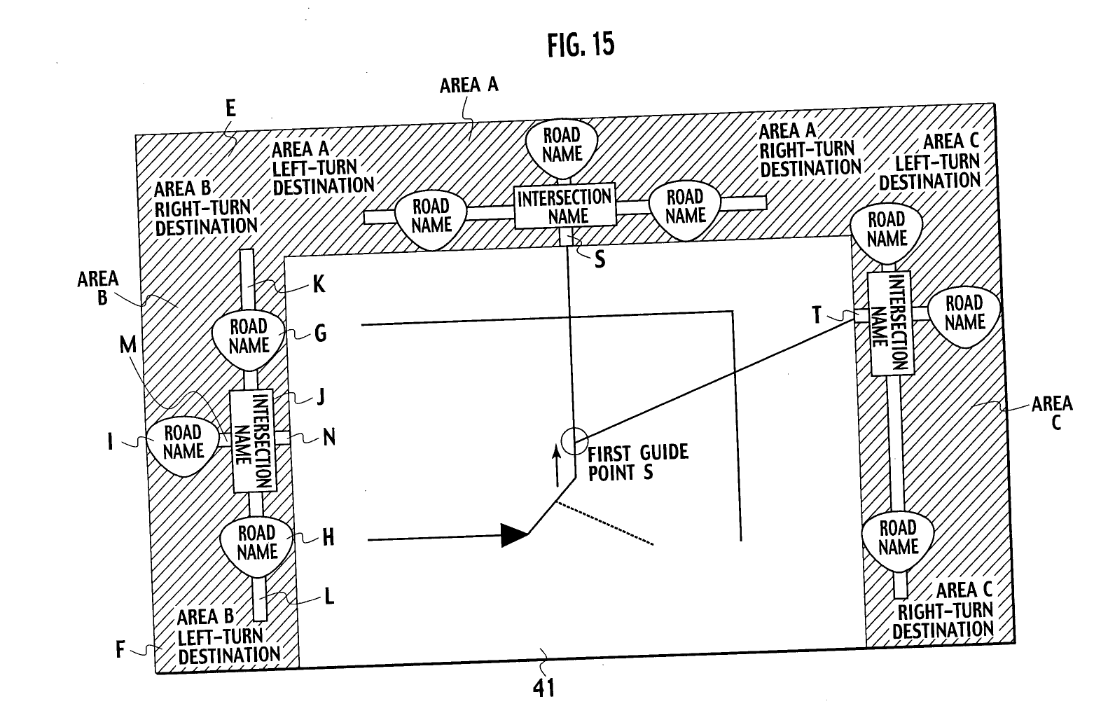

The display controlling section 3 of this embodiment displays the direction guide information generated by the direction guide area crating section 2 in the set direction guide area. The display controlling section 3 deletes the map information displayed in the area B before the direction guide information is displayed and presents the different direction guide information in the area B. When there is the direction guide information to be displayed in all the direction guide areas of the areas A to C, the direction guide areas are displayed in a manner as shown in FIG. 15. As shown in FIG. 15, the direction guide information of the embodiment includes at least the name of the second guide point, the place names of the destinations of the roads branching from the second guide points, and the names of the roads branching off from the second guide points. A specific description is given taking the direction guide information displayed in the area B as an example. The direction guide information includes a place name E of the right branch destination of the second guide point, a place name F of the left branch destination of the second guide point, a name G of a road branching right from the second guide point, a name H of a road branching left from the second guide point, a name I of a road going straight at the second guide point, an intersection name J of the second guide point, a pattern K of the road branching right from the second guide point, a pattern L of the road branching left from the second guide point, and a pattern M of the road going straight at the second guide point, and a pattern N indicating a connection relationship between the “travel path from the first guide point to the second guide point” and the “second guide point”. In this embodiment, the patterns of the roads are shown as bar-like blocks with a predetermined width along the upper edge, right edge, and left edge on the screen. With respect to the second guide point (intersection), the right block K indicates the road branching right, and the left block L indicates the road branching left. The length of the blocks may be changed according to the location of the branch destination or the end of the branching road. The patterns K, L, and M of the roads are shown with the starting point set to the second guide point, thus clearly showing the positional relationship between the second guide point and the branching roads. The schematic road diagram N shows a connection relationship between the “travel path extending from the first guide point to the second guide point” shown as the map information and the “second guide point” shown as the direction guide information and can therefore clearly exhibit the positional relationship between the direction guide information and the map information. The connection relationship between the travel path passing the area A and the second guide point is indicated by the block S, and the connection relationship between the travel path passing the area C and the second guide point is indicated by the block T.

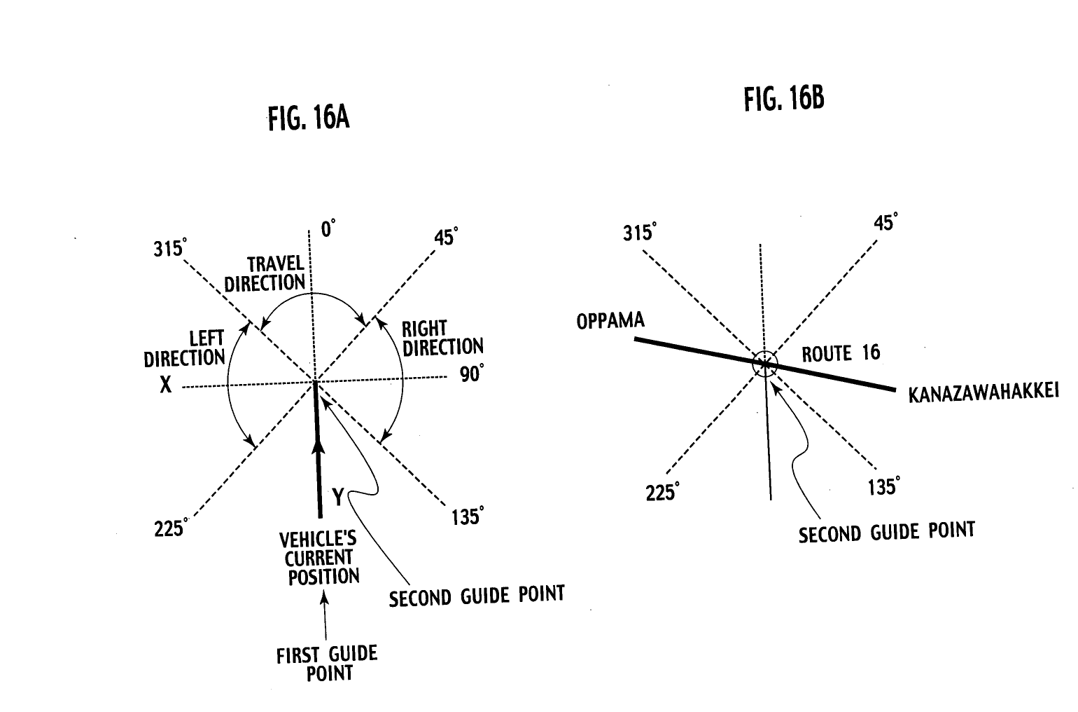

Each step of steps ST203 to ST207 is described. First, the display controlling section 3 judges whether the place name of each branch destination of the second guide point is the “name of a place in the right”, “name of a place in the left”, or “name of the place in a straight direction”. The judging method is described based on the FIGS. 16A and 16B. As shown in FIG. 16A, the display controlling section 3 determines the direction of a branch destination according to an angle with respect to a predetermined coordinate axis. Specifically, in a coordinate system with the origin set to the second guide point and with the axis Y set to the direction that the vehicle proceeds from the first guide point into the second guide point, when the destination of a road branching from the second guide point is in a direction of not less than 45° but less than 135° clockwise with respect to the axis Y, the display controlling section 3 displays the place name of the destination in the direction guide area as the “name of a place in the right direction”. In a coordinate system with the origin set to the second guide point and with the axis Y set to the direction that the vehicle proceeds from the first guide point into the second guide point, when the destination of a road branching from the second guide point is in a direction of not less than 225° but less than 315° clockwise with respect to the axis Y, the display controlling section 3 displays the place name of the destination in the direction guide area B as the “name of a place in the right direction”. In a coordinate system with the origin set to the second guide point and with the axis Y set to the direction that the vehicle proceeds from the first guide point into the second guide point, when the destination of a road branching from the second guide point is in a direction of not less than 315° but less than 45° clockwise with respect to the axis Y, the display controlling section 3 displays the place name of the destination in the direction guide area A as the “name of a place in the straight direction”. Taking a road shown in FIG. 16B as an example, the place name “Kanazawahakkei” of a destination of the road in the right direction (not less than 45° but less than 135°) is displayed in the area B, and the place name “Oihama” of a destination of the road in the left direction (not less than 225° but less than 315°) is displayed in the area B.

0104

In step ST203, the display controlling section 3 displays the “name of a place in the right” of the second guide point on the travel path passing the area B in the position E (FIG. 15) of the area B. The display controlling section 3 displays the name of the road branching right from the second guide point in the position G (FIG. 15) of the area B (ST204). The display controlling section 3 displays the “name of a place in the left” of the second guide point on the travel path passing the area B in the position F (FIG. 15) of the area B (ST205). The display controlling section 3 displays the name of the road branching left from the second guide point in the position H (FIG. 15) of the area B (ST206). The display controlling section 3 displays the name of the road in the straight direction at the second guide point in the position I (FIG. 15) of the area B (ST207). These pieces of direction guide information are generated by the direction guide information generating section 2.

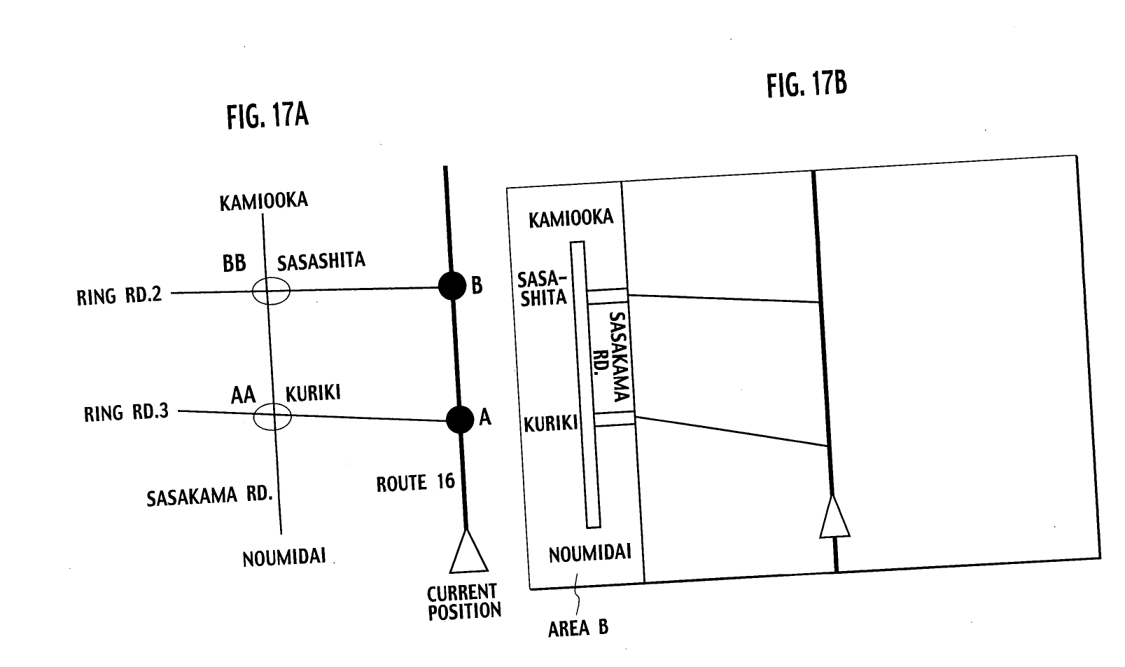

Not shown in the flowchart, a description is given of a process in the case where there are two or more branch points (second guide points) to be displayed in the same direction guide area. When the roads branching from the two or more guide points are different from each other, the display controlling section 3 displays the direction guide information of the second guide point closest to the first guide point for avoiding confusion. When there are two or more second guide points and the roads branching from the second guide points are the same, the names of the rightmost and leftmost places are displayed in the direction guide area among the place names to be displaced. For example, as shown in FIG. 17A, a description is given taking as an example the case where first guide points A and B are selected, second guide points AA and BB are selected for the first guide points A and B, and both roads extending from A to AA and from B to BB pass the area B. The turn-left destination of the second guide point AA is Noumidai, and the right branch destination thereof is Sasashita. The turn-left destination of the second guide point BB is Kuriki, and the right branch destination thereof is Kamiohoka. The display controlling section 3 sets the area B as the place where the direction guide information of the second guide points AA and BB is displayed. The display controlling section 3 does not display all the place names of the branch destinations of the second guide points AA and BB; displays the place name of “Kamiohoka” located at the rightmost side (upper side of the direction guide area in the screen) as the place name of the right branch destination; and displays the place name of “Noumidai” located at the leftmost side (lower side of the direction guide area in the screen) as the place name of the left branch destination.

In steps ST210 to ST216, the direction guide information is displayed in the area C. A process similar to a process to display the direction guide information in the area B in the step ST201 to ST207 is performed in the steps ST210 to ST216. A similar process is performed for the area A in the step 200, 220 to 227.

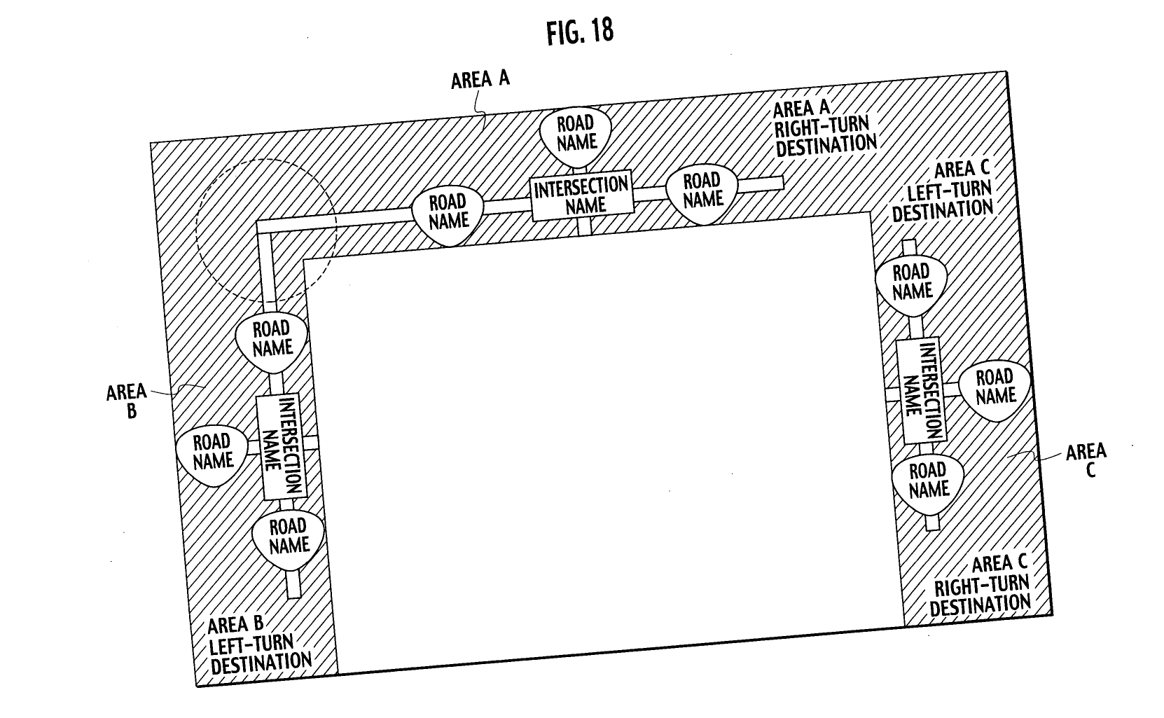

When there is the direction guide information to be displayed in the areas A and B (ST200: YES, ST221: YES), it is then judged whether the name of the road in the right direction in the area A is the same as the name of the road in the left direction in the area B (ST231). When the road names are the same, the roads of the areas A and B indicated by the patterns are connected (ST240). This state is shown in FIG. 18. As shown in a part surrounded by a dotted line of FIG. 18, the roads of the areas A and B are continuous, and the second guide point shown in the area A and the second guide point shown in area B are connected by a same road. Processes by steps T232 to T238 are the same as those by the respective steps ST202 to 207. When the place name of the left destination displayed in the area A is the same as that of the right destination displayed in the area B, these place names may be designed not to be displayed. An example thereof is shown in FIG. 18. With respect to the intersection displayed in the area A, the right destination is the “area A right destination”, and the left destination is the “area B left destination” through the specific diagram of the continuous road.

In the step ST240, in the pattern of the road continuing from the second guide point of the area A to the second guide point of the area B, the display controlling section 3 displays congestion information of the road. Moreover, in the direction guide display area with the road from the first guide point toward the second guide point in the pattern of the road, the display controlling section 3 displays congestion information of a road connecting the second guide point displayed.

In step S231 again, when the name of the road in the left direction in the area A and the name of the road in the right direction in the area B are not the same, the road name of each road is displayed.

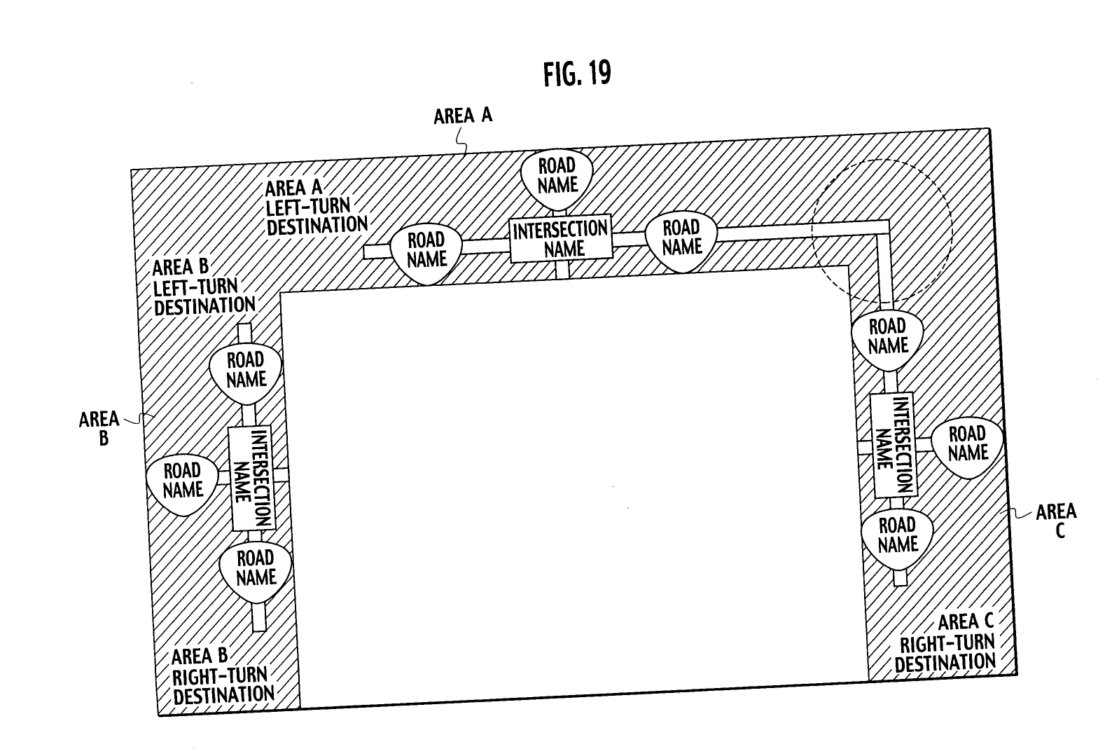

When there is the direction guide information to be displayed in the areas A and C (ST200: YES, ST221: No, ST224: YES), it is then judged whether the name of the road in the right direction in the area A is the same as the name of the road in the left direction in the area C (ST251). When the names are the same, the pattern of the road of the area A and the pattern of the road of the area B are connected (ST260). Such a state is shown in FIG. 19. As shown in a part surrounded by a dotted line of FIG. 19, the roads of the area A and the area C are continuous, and the second guide point shown in the area A and the second guide point shown in the area B are connected to each other with the same road. Processes in the steps ST252 to ST258 are the same as those in the respective steps ST202 to ST207.

When the place name of the right branch destination displayed in the area A is the same as the place name of the left branch destination displayed in the area C, these place names may not be displayed. Such an example is shown in FIG. 19. In this example, with respect to the intersection displayed in the area A, the left branch destination is the “area A left branch destination”, and the right branch destination is the “area C right branch direction” through the pattern of the continuous road.

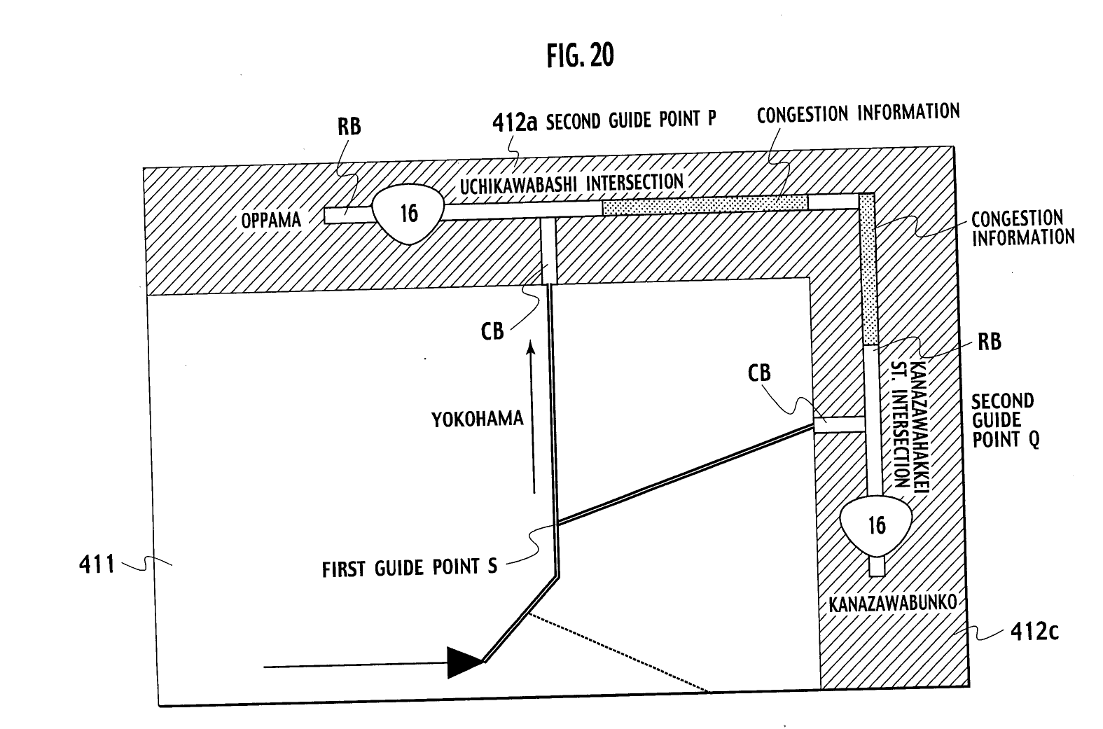

FIG. 20 shows the direction guide information and map information displayed by the display section 4 (display device) of the navigation device 200 of this embodiment. The vehicle's position shown in FIG. 20 corresponds to the vehicle's current position A shown in FIG. 9. In this example, the direction guide information of the second guide points P and Q (see FIG. 9) selected by the selecting unit 14 is displayed.

The information concerning the second guide points P and Q are as follows: the name of the second guide point Q is “Kanazawahakkei St.”; the name of the road branching right from the second guide point Q, “Route 16”; the name of the road branching left from the second guide point Q, “Route 16”; the left branch destination of the second guide point Q, “Mutsuura”; and the right branch destination of the second guide point Q, “Kanazawabunko”. The name of the second guide point P is “Kawauchibashi intersection”; the name of the road branching right from the second guide point P, “Route 16”; the name of the road branching left from the second guide point P, “Route 16”; the left branch destination of the second guide point P, “Oihama”; and the right branch destination of the second guide point P, “Kanazawahakkei”. In the screen shown FIG. 20, the direction guide information of “Kanazawahakkei St.” and “Kawauchibashi intersection”, which are the second guide points, is displayed. The direction guide information of “Kawauchibachi intersection” is displayed in the direction guide area 412a provided along the upper edge of the screen, and the direction guide information of “Kanazawahakkei St.” is displayed in the direction guide area 412b provided along the right edge of the screen. The direction guide information includes the name of each second guide point (Kawauchibashi intersection, Kanazawahakkei St.), the place names of the branch destinations of the second guide point (Oihama, Knazawabunko), and the names of the roads branching from the second guide point (Route 16). Since the name of the road branching right from the second guide point P is the same as the name of the road branching left from the second guide point Q, these roads are considered to be a continuous road, and the place names of the right branch destination of the second guide point P and of the left branch destination of the second guide point Q are not displayed. When the road branching right from the second guide point P is the same as the road branching left from the second guide point Q, display of any one of the road names is omitted for avoiding redundant display.

The roads branching off from the second guide point are schematically indicated by blocks RB with a predetermined width. The patterns with the blocks RB indicate congestion information. In this example, a block RB is separated by color according to the congested location and congestion length, thus expressing the congested location and congestion length. The black-colored part of the block RB shows congestion, the location thereof indicates the location where the congestion is caused, and the length thereof indicates the congestion length. The direction guide information is designed to include traffic information of the road through the second guide point as described above, so that the user can determined a control of the vehicle at a branch point taking into consideration the traffic information such as the congested state, traffic regulation, and constructions. For example, the user can select an uncongested route avoiding congestion.

The connection relationships between the roads from the first guide point toward the second guide points and the second guide points are displayed with blocks CB different from the blocks RB indicating roads. The user can thereby visually recognize the positional relationship between the second guide points without a scrolling operation or scale change.

In the map information shown in the map display area 411 of this example, the vehicle's travel paths are highlighted. In this example, the travel paths toward the first and second guide points are displayed with thicker lines. Furthermore, these paths are displayed with a contrast different from the image of the other part. Therefore, the user can visually recognize the locations of surrounding guide points and branch destinations thereof easily on the basis of the vehicle's travel path.

The display controlling section 3 of this embodiment displays the vehicle's travel position so that the direction that the vehicle proceeds into the first guide point is directed upward in the screen 41 at least until the vehicle has passed the first guide point. Therefore, the user can visually recognize the directions of the branch destinations of the branch point on the basis of the vehicle's travel direction.

The navigation device 200 of this embodiment is constructed and operates as described above and has the following effects.

The navigation device 200 displays the place name on the map information outside of the range displayed on the screen of the display section 4 in the direction guide area set on the screen as the direction guide information. Therefore, the user can know information such as branch destinations at a branch point not displayed on the screen without scrolling the map information or changing the map scale. The navigation device 200 is suitable especially for a case where the displayed map information is desired not to change, such as a case where the vehicle travels toward a facility or the like near the current position.

The navigation device 200 is provided with the display area along the edge of the screen. Therefore, information of a branch point located in the edge of the displayed map information can be displayed around the map information displayed in the center of the screen, and the direction guide information can be displayed according to the positional relationship between the map information and the second guide point.

Since the navigation device 200 calculates the travel path based on the map information and the vehicle's current position and selects the guide points among the branch points on the calculated travel path, the navigation device 200 can guide the branch destinations of branch points on the road where the vehicle is presumed to be likely to travel. Therefore, the user can easily recognize without setting a route where each road branching from each branch point leads with respect to the current position. It is thus possible to provide necessary information for the driver at the position where the driver needs the information. Since the travel path calculating unit 12 calculates the travel path based on at least one of the following factors: whether links constituting the path have the same identification information; whether the links have the same attribute information; and the connection angle of the link, the travel path calculating unit 12 can accurately calculate the travel path.

The road levels of links constituting the travel path are compared to select a branch point in which the road level of the link farther from the vehicle is not lower than that of the link closer to the vehicle. The direction guide information can be thereby displayed at major branch points on the travel path. Therefore, it is possible to provide necessary information for the driver at a position where the driver needs the information.

The selecting unit 14 sets as the first guide point the guide point included in the first map area corresponding to the display range of the screen and sets as the second guide point the guide point in an area included in the second map area but not included in the first map area, the second map area including the first map area. Therefore, the information concerning the branch destination of the second guide point not displayed on the screen can be displayed on the basis of the location of the first guide point. The first and second guide points are on the travel path and are selected by the same standards. Accordingly, the positional relationship thereof can be derived. Therefore, the direction guide information of the second guide point can be displayed according to the positional relationship between the second guide point and the first guide point.

The direction guide information generated by the direction guide information generating section 2 includes place names of the destinations of roads branching off from the second guide point and/or the names of the roads branching. Therefore, the user can know the directions of the branch destinations and/or the roads branching from the second guide point which is not displayed on the map without scrolling or scale change.

The direction guide information generated by the direction guide information generating section 2 includes patterns of the roads branching off from the second guide points. Therefore, the user can visually recognize the presence of roads branching from the second guide point and the directions that the roads branch. Moreover, the connection relationship between the location of the second guide point and the road from the first guide point to the second guide point is indicated by the patterns, and the user can visually recognize the connection relationship between the roads at the branch point.

The display controlling section 3 provides the direction guide area in three sides of the upper, right, and left edges of the screen. On the basis of a predetermined location, the direction guide information of the second guide point is displayed in the direction guide area which the travel path branching from the first guide point toward the second guide point passes. The direction guide information of the second guide point can be displayed in the direction of the travel path toward the second guide point. Therefore, the user can recognize all of the vehicle's travel direction, the branch directions of the first guide point, the positional relationship between the first guide point and the second guide point, and branch directions of the second guide point from information displayed on a screen.

When roads with a same name are included in each of the direction guide areas, the direction guide information generating unit 2 generates the direction guide information including the continuous road pattern. Therefore, the user can visually recognize the positional relationship on the route among the second guide points displayed in each direction guide areas.

The display controlling section 3 displays the direction guide information when the distance between the vehicle's position and the first guide point is reduced to a predetermined value, that is, when the vehicle approaches the first guide point. Therefore, the user can obtain necessary information when the user needs the information.

The display controlling section 3 displays the vehicle's travel position so that the direction that the vehicle proceeds into the first guide point is directed upward on the screen. Therefore, the user can easily recognize the directions of roads branching from the branch point. Especially in the case the guide point is after a curve, the driver can easily imagine in advance which direction the driver should turn at the guide point.

The display controlling section 3 stops the scrolling function when the distance between the vehicle 's position and the first guide point is reduced to a predetermined value. Therefore, the user can ensure to visually recognize the place names or the like in the direction guide near the branch point.

The display device 4 (display section, display) according to this embodiment includes a screen on which the map display area and the direction guide display area are displayed. In the map display area in the screen, the map information around the vehicle is displayed, and in the direction guide display area, the direction guide information is displayed, the direction guide information including the place names of the branch destinations related to a predetermined guide point selected among the branch points in the map information. Therefore, the user can visually recognize both the map information and the place names of the branch destinations or the like on a screen. The user then can know the place names of the branch destinations of the guide points without the scrolling operation or the scale change operation while checking the vehicle's position on the map.

The display controlling section 3 controlling the display process of the display device 4 displays the direction guide information of the second guide point in the direction guide display area, the second guide point being included in the second map area including the first map area corresponding to the display range of the screen but not included in the first map area. The user can thereby know the branch destinations of the guide point not included in the display range or the like without the scroll operation or the scale change operation.

The display controlling section 3 controlling the display process of the display device 4 displays the direction guide information in the direction guide display area when the distance between the vehicle's position and the first guide point included in the first map area corresponding to the display range of the screen is reduced to a predetermined value or less. In other words, when the vehicle approaches the first guide point, the screen can be switched to display the direction guide display area. Therefore, the user can obtain the direction guide information when the user needs information concerning the branch point.

The display controlling section 3 controlling the display process of the display device 4 provides the direction guide area 412 along the upper, right, and left edges of the screen 41. In the screen 41 with the origin set to the first guide point and with the axis Y set in the direction that the vehicle proceeds into the first guide point, the display controlling section 3 displays the direction guide information of the second guide point in the direction guide area passed by the travel path branching from the first guide point toward the second guide point. Accordingly, the direction guide area in which the branch destinations of the second guide point and the like are displayed can be provided in the extension direction of the travel path from the first guide point toward the second guide point, which is displayed in the map display area. The user can know the location of the first guide point, the destinations of roads branching off from the first guide point, the locations of the second guide points at the destinations of the branching roads, and the branch destinations of each second guide point on a screen. Moreover, these types of information are displayed on the screen based on the actual positional relationship, and the user can accurately recognize the directions of the branch destinations from the positional relationship between the map information and the direction guide information which are shown on the screen. Therefore, the user can easily know without setting a route where each road branching from each branch point leads with respect to the current position. Even in a place where the user does not know his/her way, the user can accurately know the geographical positions of areas guided by the direction guide information.

In this embodiment, the navigation device 200 has been described, and a display device of the present invention is equivalent to the display section 4 of the navigation device 200. Moreover, a display controlling section of the display device is equivalent to the display controlling section 3 of the navigation device 200. Furthermore, a navigation program of the present invention executed by a computer operates in a similar manner and has similar effects.

The entire content of a Patent Application No. TOKUGAN 2003-393510 with a filing date of Nov. 25, 2003, and a Patent Application No. TOKUGAN 2003-402888 with a filing date of Dec. 2, 2003, are hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

1. A navigation device presenting direction guide information on a display section at a branch point of a travel path where a vehicle with the navigation device mounted thereon travels, the direction guide information including a place name of a branch destination of the travel path, the navigation device comprising:
a guide point selecting means for selecting a guide point related to the direction guide information among branch points on the travel path;
a direction guide information generating means for generating the direction guide information of the guide point selected by the guide point selecting means; and
a display controlling means for controlling display of the direction guide information generated by the guide information generating means, wherein
the direction guide information generating means generates the direction guide information in which the guide point is associated with display of the place name of the branch destination at the guide point.

2. A navigation device presenting direction guide information on a display section at a branch point of a travel path where a vehicle with the navigation device mounted thereon travels, the direction guide information including a place name of a branch destination of the travel path, the navigation device comprising:
a guide point selecting section selecting a guide point related to the direction guide information among branch points on the travel path;
a direction guide information generating section generating the direction guide information of the guide point selected by the guide point selecting section; and
a display controlling section controlling display of the direction guide information generated by the guide information generating section, wherein
the direction guide information generating section generates the direction guide information in which the guide point is associated with display of the place name of the branch destination at the guide point.

3. The navigation device according to claim 2, wherein
the display controlling section sets a direction guide area, in which the direction guide information generated by the direction guide information generating section is displayed, on a screen of the display section, and displays the direction guide information in the set direction guide area, and the direction guide information includes information of a branch destination of the guide point outside of map information which can be displayed on the screen.

4. The navigation device according to claim 2, wherein
the direction guide area includes at least a display area provided along an edge of the screen.

5. The navigation device according to claim 4, wherein
the guide point selecting section includes: a map information acquiring unit acquiring stored map information; a travel path calculating section calculating the travel path based on the map information and a detected current position of the vehicle; a branch point detecting unit detecting branch points on the calculated travel path, and a selecting unit selecting the guide point among the branch points detected by the branch point detecting unit.

6. The navigation device according to claim 5, wherein
the selecting unit acquires road levels concerning the road scale, which are previously associated with links constituting roads included in the map information, compares the road levels of adjacent links at the branch points detected by the branch point detecting unit, selects as the guide points the branch points at which the road level of the link farther from the vehicle is not lower than the road level of the link closer to the vehicle.

7. The navigation device according to claim 6, wherein
the selecting unit: sets first and second map areas in the map information, the first map area corresponding to the display range of the screen, the second map area including the first map area; and, among the selected guide points, selects the guide point included in the first map area as a first guide point and selects the guide point not included in the first guide area but included in the second map area as a second guide point.

8. The navigation device according to claim 7, wherein
the direction guide information generating section generates the direction guide information including a place name of a destination of a road branching from the second guide point and/or a name of the road branching from the second guide point.

9. The navigation device according to claim 7, wherein
the direction guide information generating section generates the direction guide information including a pattern of the road branching from the second guide point.

10. The navigation device according to claim 9, wherein
the pattern of the road indicates a connection relationship between the location of the second guide point and a road from the first guide point to the second guide point.

11. The navigation device according to claim 7, wherein
the direction guide information generating section acquires traffic information on the road branching from the second guide point and generates the direction guide information including the acquired traffic information.

12. The navigation device according to claim 7, wherein
the screen of the display section is rectangular, and the display controlling section provides direction guide areas along upper, right, and left edges of the screen, and
in the screen with the origin set to the first guide point and with an axis Y set to a direction that the vehicle proceeds into the first guide point, the display controlling section displays the direction guide information of the second guide point in the direction guide area passed by the travel path branching from the first guide point toward the second guide point.

13. The navigation device according to claim 12, wherein
when a name of a road branching right from the second guide point displayed in the direction guide area in the upper edge is the same as a name of a road branching left from the second guide point displayed in the direction guide area in the right edge, the direction guide information generating section generates the direction guide information including a pattern of a road continuing from the second guide point displayed in the direction guide area in the upper edge to the second guide point displayed in the direction guide area in the right edge, and
when a name of a road branching left from the second guide point displayed in the direction guide area in the upper edge is the same as a name of a road branching right from the second guide point displayed in the direction guide area in the left edge, the direction guide information generating section generates the direction guide information including a pattern of a road continuing from the second guide point displayed in the direction guide area in the upper edge to the second guide point displayed in the direction guide area in the left edge.

14. The navigation device according to claim 7, wherein
the display controlling section presents the direction guide information when the distance between the location of the vehicle and the first guide point is reduced to a predetermined value or less.

15. The navigation device according to claim 7, wherein
the display controlling section presents the map information so that the direction that the vehicle proceeds into the first guide point is directed upward at least until the vehicle passes the first guide point.

16. The navigation device according to claim 7, wherein
the display controlling section stops a scrolling function when the distance between the location of the vehicle and the first guide point is reduced to a predetermined value or less.

17. The navigation device according to claim 2, wherein
the direction guide information generating section generates the direction guide information in which a road from a current position of the vehicle to the guide point and a road branching from the guide point are highlighted.

18. The navigation device according to claim 2, wherein
the guide point selecting section generates the direction guide information including traffic information of a road through the guide point.

19. The navigation device according to claim 2, wherein
the guide point selecting section includes: a map information acquiring unit acquiring stored map information; a travel path calculating section calculating the travel path based on the map information and a detected current position of the vehicle; a branch point detecting unit detecting branch points on the calculated travel path, and a selecting unit selecting the guide point among the branch points detected by the branch point detecting unit.

20. The navigation device according to claim 19, wherein
the travel path calculating unit acquires identification information, attribute information, and a connection angle, which are previously associated with links constituting roads included in the map information, and
calculates the travel path based on at least any one of whether the links have the same identification information, whether the links have the same attribute information, and the connection angle of the links.

21. The navigation device according to claim 19, wherein
the selecting unit acquires road levels concerning a road scale, which are previously associated with links constituting roads included in the map information, compares the road levels of adjacent links at each of the branch points selected by the branch point detecting unit, selects as the guide point the branch point at which the road level of the link farther from the vehicle is not lower than the road level of the link closer to the vehicle.

22. The navigation device according to claim 19, wherein
the selecting unit acquires road levels concerning the road scale, which are previously associated with links constituting roads included in the map information, compares the road levels of the adjacent links at the branch points detected by the branch point detecting unit, selects branch point candidates at which the road level of the link farther from the vehicle is not lower than the road level of the link closer to the vehicle, and selects as a first guide point the branch point closest to the vehicle among the selected branch point candidates.

23. The navigation device according to claim 22, wherein
the selecting unit selects as a second guide point the branch point second closest to the vehicle among the selected branch point candidates.

24. The navigation device according to claim 22, wherein
the display controlling section presents the direction guide information when the distance between the position of the vehicle and the first guide point is reduced to a predetermined value or less.

25. The navigation device according to claim 22, wherein
the display controlling section presents the direction guide information so that the direction that the vehicle proceeds into the first guide point is directed upward at least until the vehicle passes the first guide point.

26. The navigation device according to claim 22, wherein
the display controlling section stops a scrolling function when the distance between the position of the vehicle and the first guide point is reduced to a predetermined value or less.

27. The navigation device according to claim 22, wherein
the display controlling section presents an image of a road from the position of the vehicle to the first guide point and a road branching from the first guide point and an image of the other part at different contrasts.

28. The navigation device according to claim 23, wherein
the display controlling section presents an image of a road from the position of the vehicle to the first guide point, a road from the first guide point to the second guide point, and a road branching from the first guide point and an image of the other part at different contrasts.

29. The navigation device according to claim 23, wherein
the display controlling section changes a scale of the direction guide information and presents the direction guide information including the first and second guide points on the display section.

30. A car navigation program causing a navigation computer mounted on a vehicle to execute a process, the navigation computer including a function to present direction guide information including a place name of a branch destination of a travel path, where the vehicle travels, at a branch point of the travel path, wherein the process includes:
a process to select a guide point related to the direction guide information among branch points on the travel path;
a process to generate the direction guide information of the selected guide point; and
a process to control output of the generated direction guide information, wherein
the process to generate the direction guide information includes a process to generate the direction guide information in which the guide point is associated with display of the place name of the branch destination at the guide point.

31. The car navigation program according to claim 30, wherein
the process to select the guide point includes: a process to calculate the travel path based on the map information and a detected current position of the vehicle; a process to detect branch points on the calculated travel path, and a process to select the guide point among the detected branch points.

32. The car navigation program according to claim 31, wherein
the process to calculate the travel path acquires identification information, attribute information, and a connection angle, which are previously associated with links constituting roads included in the map information, and calculates the travel path based on at least any one of whether the links have the same identification information, whether the links have the attribute information, and the connection angle of the links.

33. The car navigation program according to claim 31, wherein
the process to select the guide point acquires road levels concerning a road scale, which are previously associated with links constituting roads included in the map information, compares the road levels of adjacent links at each of the detected branch points, selects as the guide point the branch point at which the road level of the link farther from the vehicle is not lower than the road level of the link closer to the vehicle.

34. A display device mounted on a vehicle, comprising:
a screen including a map display area and a direction guide information; and
a display controlling section controlling display on the screen, wherein
the display controlling section displays map information around the vehicle in the map display area of the screen and displays direction guide information including information of a branch destination related to a selected predetermined guide point in the direction guide display area.

35. The display device according to claim 34, wherein
the display controlling section sets first and second map areas in the map information, the first map area corresponding to the display range of the screen, the second map area including the first map area; and in the direction guide area, displays the direction guide information of the second guide point included in the second map area but not included in the first map area.

36. The display device according to claim 35, wherein
the display controlling section displays the direction guide information in the direction guide display area when the distance between the position of the vehicle and the first guide point included in the first map area corresponding to the display range of the screen is reduced to a predetermined value or less.

37. The display device according to claim 35, wherein
the display controlling section provides direction guide areas along upper, right, and left edges of the screen, and wherein,
in the screen with the origin set to the first point and with an axis Y set to a direction that the vehicle proceeds into the first guide point, the display controlling section displays the direction guide information of the second guide point in the direction guide area passed by the travel path branching from the first guide point toward the second guide point.

38. A display control program causing a computer for controlling display of a display device mounted on a vehicle to execute a process, wherein
the process includes a process to select a guide point outside of map information which can be displayed in the screen among branch points on a travel path where the vehicle travels; a process to generate direction guide information including information of a branch destination related to the selected guide point; and a process to set a direction guide area, in which the generated direction guide information is displayed, in the screen of the display device and display the direction guide information in the set direction guide area.

39. The display control program according to claim 38, wherein
the process to select the guide point includes a process to acquire stored map information, a process to calculate the travel path based on the map information and a detected current position of the vehicle, a process to detect branch points on the calculated travel path, and a process to select the guide point among the detected branch points.

40. The display control program according to claim 39, wherein
the process to select the guide point includes a process to set first and second map areas in the map information, the first map area corresponding to the display range of the screen, the second map area including the first map area; and among the selected guide points, select the guide point included in the first map area as a first guide point, and as the second guide point, select the guide point not included in the first map area but included in the second map area.

41. The display control program according to claim 40, wherein
the process to display the direction guide information in the direction guide area includes: a process to provide direction guide areas along upper, right, and left edges of the rectangular screen; and a process to, in the screen with the origin set to the first point and with an axis Y set to a direction that the vehicle proceeds into the first guide point, display the direction guide information of the second guide point in the direction guide area passed by the travel path branching from the first guide point toward the second guide point.
